(19) United States
(12) Patent Application Publication
(10) Pub. No.: US 2025/0181100 A1
(43) Pub. Date: Jun. 5, 2025

(54) BANDGAP REFERENCE CIRCUIT AND SEMICONDUCTOR DEVICE

(71) Applicants: Nuvoton Technology Corporation Japan, Kyoto (JP); Nuvoton Technology Singapore Pte. Ltd., Singapore (SG)

(72) Inventors: Kazuhito ITO, Osaka (JP); Hitoshi KOBAYASHI, Osaka (JP); Michiko YAMADA, Kyoto (JP); Satoshi ENDO, Osaka (JP); Hong Meng TANG, Singapore (SG)

(21) Appl. No.: 19/050,831

(22) Filed: Feb. 11, 2025

Related U.S. Application Data
(63) Continuation of application No. PCT/JP2023/028202, filed on Aug. 1, 2023.

(30) Foreign Application Priority Data
Aug. 26, 2022 (JP) 2022-134742

(51) Int. Cl. G05F 3/30

(52) U.S. Cl. CPC G05F 3/30

(57) ABSTRACT

A bandgap reference circuit includes: a diode characteristic element group; a dynamic element matching circuit that repeats, within a predetermined period, an operation of selecting, from the diode characteristic element group, a first diode characteristic element group including M diode characteristic elements connected in parallel and a second diode characteristic element group including N (≥M) diode characteristic elements connected in parallel, while changing a combination of the diode characteristic elements to be selected; a reference voltage generation circuit that generates a reference voltage based on a difference between a current density of current passing through the first diode characteristic element group and a current density of current passing through the second diode characteristic element group; and a second-order temperature coefficient adjustment circuit that adjusts a second-order temperature coefficient of the reference voltage generated.

### CROSS REFERENCE TO RELATED APPLICATIONS

This is a continuation application of PCT International Patent Application No. PCT/JP2023/028202 filed on Aug. 1, 2023, designating the United States of America, which is based on and claims priority of Japanese Patent Application No. 2022-134742 filed on Aug. 26, 2022. The entire disclosures of the above-identified applications, including the specifications, drawings and claims are incorporated herein by reference in their entirety.

### FIELD

The present disclosure relates to a bandgap reference circuit that generates a reference voltage, and a semiconductor device that includes the bandgap reference circuit.

### BACKGROUND

As a bandgap reference circuit that generates a reference voltage having excellent temperature characteristics, a reference voltage generating circuit that includes: a reference voltage generating circuit element that generates a reference voltage based on a difference between a voltage applied to a first diode characteristic element and a voltage applied to a second diode characteristic element with a density of the current flowing therethrough being different from a density of the current flowing through the first diode characteristic element has conventionally been proposed (see Patent Literature (PTL) 1, for example).

### CITATION LIST

### Patent Literature

PTL 1: Japanese Patent No. 5842164

### SUMMARY

### Technical Problem

However, although the technique of PTL 1 improves the temperature characteristics of the reference voltage to be generated, unfortunately, characteristic variation occurs among a plurality of reference voltage generating circuits manufactured, depending on the characteristic variation of the first diode characteristic element and the second diode characteristic element that are used. It should be noted that the characteristic variation is, unless otherwise specified, the variation in characteristics between individual units, and is also referred to as manufacturing variation.

In view of the above, the present disclosure provides a bandgap reference circuit with reduced characteristic variation, and a semiconductor device that includes such a bandgap reference circuit.

### Solution to Problem

In order to achieve the above, a bandgap reference circuit according to one aspect of the present disclosure includes: a diode characteristic element group including a plurality of diode characteristic elements; a dynamic element matching circuit that repeats, within a predetermined period, an operation of selecting, from the diode characteristic element group, a first diode characteristic element group including M diode characteristic elements connected in parallel and a second diode characteristic element group including N diode characteristic elements connected in parallel, while changing a combination of the M diode characteristic elements and the N diode characteristic elements to be selected, M being an integer greater than or equal to 1, N being an integer greater than or equal to 2 and greater than M; a reference voltage generation circuit that generates a reference voltage based on a difference between a current density of current passing through the first diode characteristic element group and a current density of current passing through the second diode characteristic element group; and a second-order temperature coefficient adjustment circuit that adjusts a second-order temperature coefficient of the reference voltage generated in the reference voltage generation circuit.

In addition, in order to achieve the above, a semiconductor device according to one aspect of the present disclosure includes: the bandgap reference circuit described above; and a time discrete filter that receives the reference voltage output from the bandgap reference circuit. In the semiconductor device, the dynamic element matching circuit repeats the operation in synchronization with a clock signal, and the time discrete filter performs time discrete filtering in synchronization with the clock signal.

### Advantageous Effects

The present disclosure provides a bandgap reference circuit with reduced characteristic variation, and a semiconductor device that includes such a bandgap reference circuit.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a circuit block diagram illustrating a configuration of a semiconductor device that includes a bandgap reference circuit according to an embodiment.

FIG. 2 is a block diagram illustrating a function of a dynamic element matching circuit illustrated in FIG. 1.

FIG. 3 is a diagram illustrating a diode characteristic element group and a switch group illustrated in FIG. 1.

FIG. 4 is a timing chart illustrating an operation example of the dynamic element matching circuit illustrated in FIG. 3.

FIG. 5 is a diagram explaining the transition of a selection state illustrated in FIG. 4.

FIG. 6A is a diagram illustrating a diode characteristic element group and a switch group according to a variation.

FIG. 6B is a timing chart illustrating an operation example of a dynamic element matching circuit according to the variation illustrated in FIG. 6A.

FIG. 6C is a diagram explaining the transition of a selection state illustrated in FIG. 6B.

FIG. 6D is a diagram explaining the transition of a selection state according to a reference example.

FIG. 7 is a diagram illustrating a result of simulation comparing the amount of variation (noise) in the reference voltage between the variation illustrated in FIG. 6C and the reference example illustrated in FIG. 6D.

FIG. 8 is a circuit diagram illustrating a configuration example of a switch selection circuit that implements a dynamic element matching circuit according to the variation in which randomness is incorporated.

FIG. 9A is a timing chart illustrating an operation of the switch selection circuit illustrated in FIG. 8.

FIG. 9B is a diagram illustrating the diode characteristic elements selected as a first diode characteristic element group by the switch selection circuit illustrated in FIG. 8.

FIG. 10 is a diagram explaining the advantageous effects resulting from the operation of the dynamic element matching circuit according to the variation in which randomness is incorporated illustrated in FIG. 8.

FIG. 11 is a diagram illustrating a configuration example of a switch selection circuit that implements a dynamic element matching circuit according to the variation in which delta-sigma modulation is incorporated.

FIG. 12 is a diagram illustrating a layout of the diode characteristic element group on a substrate according to the variation.

FIG. 13 is a circuit block diagram illustrating a configuration of a semiconductor device according to the variation in which a bipolar transistor included in a second-order temperature coefficient adjustment circuit is included in the diode characteristic element group, and is subjected to dynamic element matching.

FIG. 14 is a circuit diagram illustrating a detailed configuration of the dynamic element matching circuit group illustrated in FIG. 13.

FIG. 15 is a circuit diagram illustrating a detailed configuration example of a first switch circuit and a second switch circuit illustrated in FIG. 1.

FIG. 16A is a circuit diagram illustrating a detailed configuration example of a time discrete filter illustrated in FIG. 1.

FIG. 16B is a timing chart illustrating an operation of the time discrete filter illustrated in FIG. 16A.

FIG. 17A is a circuit block diagram illustrating a configuration of a semiconductor device according to the variation which includes an averaging filter as an analog signal processing circuit in place of the time discrete filter, the AD converter, and the averaging filter according to the embodiment.

FIG. 17B is a circuit diagram illustrating a detailed configuration of the averaging filter illustrated in FIG. 17A.

FIG. 17C is a diagram illustrating an example of one period in which the averaging filter illustrated in FIG. 17A performs the averaging processing.

### DESCRIPTION OF EMBODIMENT

The following describes in detail an embodiment and variations thereof according to the present disclosure, with reference to the drawings. It should be noted that each of the embodiment and the variations thereof described below shows one specific example of the present disclosure. The numerical values, shapes, materials, structural components, the arrangement and connection of the structural components, signal waveforms, signal timing, etc. described in the following the embodiment and the variations thereof are mere examples, and therefore do not limit the scope of the present disclosure. In addition, the respective diagrams are not necessarily precise illustrations. Throughout the drawings, the same reference sign is given to substantially the same structural component, and redundant description will be omitted or simplified. In addition, the term “A and B are connected” means that A and B are electrically connected, and includes not only the case where A and B are directly connected but also the case where A and B are indirectly connected with other circuit elements between A and B.

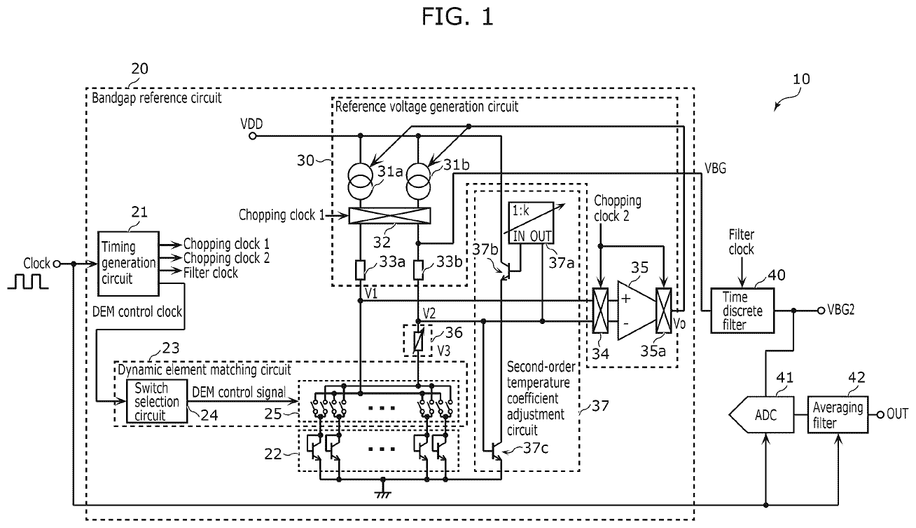

FIG. 1 is a circuit block diagram illustrating a configuration of semiconductor device 10 that includes bandgap reference circuit 20 according to the embodiment. Semiconductor device 10 includes: bandgap reference circuit 20 that generates reference voltage VBG; time discrete filter 40 that outputs reference voltage VBG2 obtained by performing time discrete filter processing on reference voltage VBG that has been generated; AD converter 41 that converts reference voltage VBG2 that has been output into a digital signal; and averaging filter 42 that averages the digital signal that has been output.

Bandgap reference circuit 20 includes: timing generation circuit 21; diode characteristic element group 22; dynamic element matching circuit 23; reference voltage generation circuit 30; first-order temperature coefficient adjustment circuit 36; and second-order temperature coefficient adjustment circuit 37.

Timing generation circuit 21 generates, based on a clock provided from outside, chopping clock 1 to be supplied to first switch circuit 32, chopping clock 2 to be supplied to second switch circuit 34, a filter clock to be supplied to time discrete filter 40, and a dynamic element matching (DEM) control clock to be supplied to dynamic element matching circuit 23.

Diode characteristic element group 22 is composed of a plurality of diode characteristic elements with one end (cathode) connected in common (in this case, to ground). A diode characteristic element is an element that functionally includes an anode and a cathode, and has diode characteristics. The diode characteristic element is, for example, a diode, an NPN bipolar transistor to which a collector and a base are connected, or the like. According to the present embodiment, the base-emitter voltage of an NPN bipolar transistor to which a collector and a base are connected is used as the band gap voltage.

Dynamic element matching circuit 23 includes: switch group 25 including a plurality of switches that connect the anodes of the plurality of diode characteristic elements that constitute diode characteristic element group 22 to connection point V1 for generating reference voltage V1 or connection point V3 for generating reference voltage V3; and switch selection circuit 24 that outputs a DEM control signal for controlling the on-off of each of the switches that constitute switch group 25 according to the DEM control clock from timing generation circuit 21.

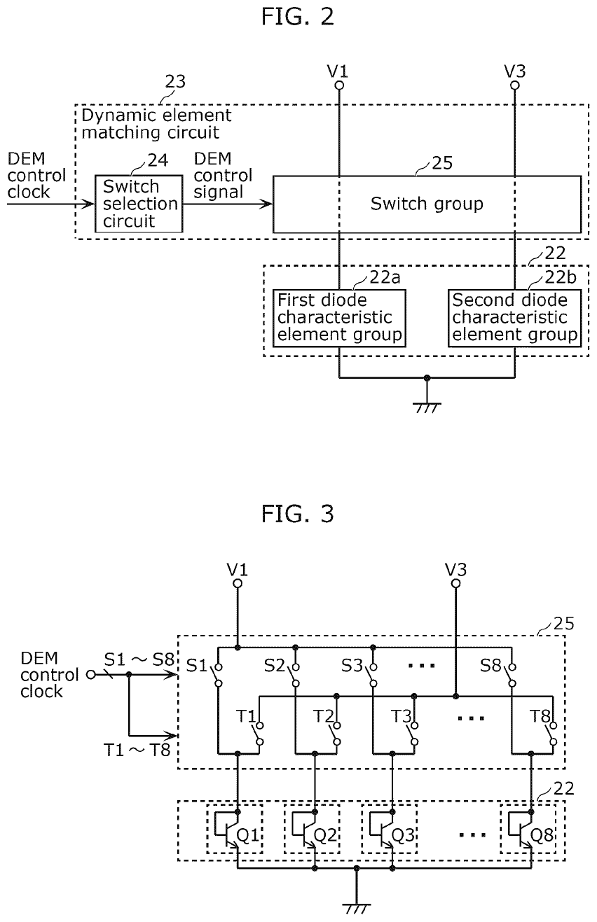

Dynamic element matching circuit 23, functionally, as illustrated in the functional block diagram of dynamic element matching circuit 23 in FIG. 2, repeats, within a predetermined period, an operation of selecting, from diode characteristic element group 22, first diode characteristic element group 22a including M diode characteristic elements connected in parallel, and second diode characteristic element group 22b including N diode characteristic elements connected in parallel, while changing the combination of M diode characteristic elements and N diode characteristic elements to be selected. M is an integer greater than or equal to 1. N is an integer greater than or equal to 2 and greater than M.

Reference voltage generation circuit 30 is a circuit that generates reference voltage VBG based on the difference between the current density of the current passing through first diode characteristic element group 22a and the current density of the current passing through second diode characteristic element group 22b (in other words, the difference in averaged diode characteristic voltage (i.e., band gap voltage)). Reference voltage generation circuit 30 includes: first current supply 31a; second current supply 31b; first switch circuit 32, first resistor element 33a, second resistor element 33b, second switch circuit 34, and differential amplifier 35.

First current supply 31a and second current supply 31b are each a variable current supply that includes one end connected to power supply voltage VDD and outputs current of the same magnitude as each other according to output voltage Vo of differential amplifier 35. First current supply 31a and second current supply 31b output current with a magnitude adjusted in the direction of negative feedback to differential amplifier 35.

First switch circuit 32 is a circuit that periodically switches, according to chopping clock 1 from timing generation circuit 21, the current supply which supplies current to first diode characteristic element group 22a and the current supply which supplies current to second diode characteristic element group 22b between first current supply 31a and second current supply 31b.

First resistor element 33a and second resistor element 33b have the same resistance value as each other. First resistor element 33a is a current limiting element inserted into the path (hereinafter, this path is also referred to as a “first path”) through which current passes to first diode characteristic element group 22a via switch group 25. Second resistor element 33b is a current limiting element inserted into the path (hereinafter, this path is also referred to as a “second path”) through which current passes to second diode characteristic element group 22b via switch group 25 and first-order temperature coefficient adjustment circuit 36.

Differential amplifier 35 is an amplifier that includes a non-inverting input terminal (first input terminal) and an inverting input terminal (second input terminal) to which voltage V1 dependent on the current density of the current passing through first diode characteristic element group 22a (that is, the first voltage at connection point V1 between first resistor element 33a and switch group 25) and voltage V2 dependent on the current density of the current passing through second diode characteristic element group 22b (that is, the second voltage at connection point V2 between second resistor element 33b and first-order temperature coefficient adjustment circuit 36) are input via second switch circuit 34. Differential amplifier 35 amplifies, and outputs as output voltage Vo, the difference between the voltage that has been input to the non-inverting input terminal and the voltage that has been input to the inverting input terminal. Differential amplifier 35, according to chopping clock 2 from timing generation circuit 21, switches the connection mode of internal circuit 35a such that the same amplification operation is performed when the non-inverting input terminal and the inverting input terminal are functionally switched or not switched, in synchronization with the switching operation of second switch circuit 34.

Second switch circuit 34 is a switch circuit that periodically switches, according to chopping clock 2 from timing generation circuit 21, the voltage input to the non-inverting input terminal of differential amplifier 35 and the voltage input to the inverting input terminal of differential amplifier 35 between voltage V1 and voltage V2.

First-order temperature coefficient adjustment circuit 36 is a variable resistor element connected in series to second resistor element 33b, and is adjusted to a resistance value to bring the first-order temperature coefficient of reference voltage VBG generated in reference voltage generation circuit 30 close to zero.

Second-order temperature coefficient adjustment circuit 37 is a circuit that adjusts the second-order temperature coefficient of reference voltage VBG generated in reference voltage generation circuit 30, and includes: two bipolar transistors 37b and 37c connected in series between power supply voltage VDD and ground; and current mirror circuit 37a that receives the base current of bipolar transistor 37b as input (i.e., 1) and outputs variable current with the relationship of a current ratio of 1:k to connection point V2. The current ratio of 1:k of current mirror circuit 37a is adjusted to a value to bring the second-order temperature coefficient of reference voltage VBG generated in reference voltage generation circuit 30 close to zero.

Next, an operation of semiconductor device 10 according to the present embodiment having the above-described configuration will be described.

First, the overall operation will be described.

In the first path including connection point V1, the current output from first current supply 31a or second current supply 31b passes through first resistor element 33a via first switch circuit 32, and further passes through first diode characteristic element group 22a including M diode characteristic elements connected in parallel which have been selected by switch group 25 in dynamic element matching circuit 23.

On the other hand, in the second path including connection point V2, the current output from second current supply 31b or first current supply 31a passes through second resistor element 33b and first-order temperature coefficient adjustment circuit 36 via first switch circuit 32, and further passes through second diode characteristic element group 22b including N diode characteristic elements connected in parallel which have been selected by switch group 25 in dynamic element matching circuit 23. Current flows in and out between connection point V2 and second-order temperature coefficient adjustment circuit 37.

Here, voltage V1 at connection point V1 is the averaged diode characteristic voltage of first diode characteristic element group 22a, while voltage V2 at connection point V2 is the voltage obtained by adding the drop voltage at first-order temperature coefficient adjustment circuit 36 to the averaged diode characteristic voltage of second diode characteristic element group 22b (third voltage at connection point V3).

Voltages V1 and V2 as described above are input to differential amplifier 35 via second switch circuit 34, and output voltage Vo from differential amplifier 35 is negatively fed back to adjust the output current of first current supply 31a and second current supply 31b.

The voltage at the connection point between first switch circuit 32 and second resistor element 33b is output from reference voltage generation circuit 30 as reference voltage VBG, and input to time discrete filter 40. In time discrete filter 40, the voltage variation (noise) of the voltage caused by the switching operation in dynamic element matching circuit 23, first switch circuit 32, and second switch circuit 34 is suppressed, and the voltage is input to AD converter 41 as reference voltage VBG2.

In AD converter 41, reference voltage VBG2 is converted to a digital signal, and the digital signal is averaged by digital signal processing such as moving average in averaging filter 42.

Next, the purpose of first-order temperature coefficient adjustment circuit 36 will be explained.

In reference voltage generation circuit 30, since the magnitudes of the current output by first current supply 31a and second current supply 31b are equal to each other, the resistance values of first resistor element 33a and second resistor element 33b are equal to each other, and voltage V1 and voltage V2 are equal to each other because the negative feedback of differential amplifier 35 causes an immersion short between the non-inverting input terminal and the inverting input terminal. In addition, since the voltage obtained by adding the drop voltage at second resistor element 33b to voltage V2 is reference voltage VBG, the first-order differential component dVBG/dT of reference voltage VBG with respect to temperature T is represented by the following Expression 1.

$$dVBG / dT = dVf 2 / dT + ( k / q ) \cdot ( In ( n ) \cdot ( R 2 + R 3 ) / R 3 \qquad ( Expression 1 )$$

Here, Vf2 is the forward voltage of second diode characteristic element group 22b, k is Boltzmann's constant, q is the elementary charge, In represents the natural logarithm, n is the current density ratio of first diode characteristic element group 22a to second diode characteristic element group 22b (here, N/M), R2 is the resistance value of second resistor element 33b, and R3 is the resistance value of first-order temperature coefficient adjustment circuit 36.

Accordingly, the first-order temperature coefficient of reference voltage VBG can be set to zero by adjusting resistance value R3 of first-order temperature coefficient adjustment circuit 36 so that the value of Expression 1 described above takes zero. For example, when n=8, R2=90 kΩ, and dVf2/dT=−1.8 mV/° C., resistance value R3 of the primary temperature coefficient adjustment circuit 36 is 10 kΩ. Note that k/q=86.17 μV.

Next, the purpose of second-order temperature coefficient adjustment circuit 37 will be explained.

The second order differential with respect to t=ΔT/T0 for the series expansion VBG0(T) of band gap voltage VBG0 with respect to temperature T can be approximated by d²VBG0(t)/dt²=2·a2, the band gap voltage VBG0 being the band gap voltage of second diode characteristic element group 22b to generate reference voltage VBG. It should be noted that the third and subsequent terms are ignored because they are negligible in the assumed temperature range. Here, T0 is the reference temperature, ΔT is the temperature difference between temperature T and reference temperature T0, and a2 is the constant of the second order term in the above-described series expansion.

Reference voltage generation circuit 30 outputs reference voltage VBG(t) in which the secondary temperature coefficient is canceled out by adding, to band gap voltage VBG0(t), adjustment current Ic(t) from second-order temperature coefficient adjustment circuit 37. In other words, since it can be represented as VBG(t)=VBG0(t)−R2·Ic(t), the second order differential d²VBG(t)/dt² of reference voltage VBG(t) with respect to temperature t is represented by the following Expression 2.

$${d}^{2} VBG ( t ) / dt 2 = 2 \cdot a 2 - R 2 \cdot {d}^{2} Ic ( t ) / {dt}^{2} \qquad ( Expression 2 )$$

Accordingly, it is possible to set the second-order temperature coefficient of reference voltage VBG to zero, by adjusting adjustment current Ic(t) output from second-order temperature coefficient adjustment circuit 37 such that the above Expression 2 becomes zero when t=0; that is, when temperature T is reference temperature TO (e.g., 27° C.=300 K).

More specifically, when adjustment current Ic(t) is the current expressed as Ic(t)=C·exp(−t) using constant C, the second-order temperature coefficient of reference voltage VBG can be set to zero by setting adjustment current Ic(t) to satisfy Ic(t)=2·a2/(R2·C). Otherwise, adjustment current Ic(t) may be the current expressed by Ic(t)=C/t using constant C.

Next, an example of the operation of dynamic element matching circuit 23 will be described.

FIG. 3 is a diagram illustrating diode characteristic element group 22 and switch group 25 illustrated in FIG. 1. Diode characteristic element group 22 is composed of eight NPN bipolar transistors to which the collector and base are connected, as diode characteristic elements Q1 to Q8 of a power of two (in this case, eight). The eight diode characteristic elements Q1 to Q8 each have one end (cathode) that is connected in common (in this case, to ground).

Switch group 25 includes: switches S1 to S8 for connecting the other end (anode; collector and base of the NPN bipolar transistor) of each of the eight diode characteristic elements Q1 to Q8 to connection point V1; and switches T1 to T8 for connecting it to connection point V3. In switch group 25, on-off of switches S1 to S8 are controlled by control signals S1 to S8 included in the DEM control signal from switch selection circuit 24, and on-off of switches T1 to T8 are controlled by control signals T1 to T8 included in the DEM control signal. In this manner, first diode characteristic element group 22a which includes M diode characteristic elements connected in parallel and second diode characteristic element group 22b which includes N diode characteristic elements connected in parallel are determined in diode characteristic element group 22.

Since diode characteristic element group 22 is composed of diode characteristic elements of a power of two, namely Q1 to Q8, it is possible to simplify the frequency divider circuit which is included by dynamic element matching circuit 23 (in particular, switch selection circuit 24 that outputs a DEM control signal to switch group 25) for selecting the combination of first diode characteristic element group 22a and second diode characteristic element group 22b in diode characteristic element group 22, and also to facilitate the averaging in time discrete filter 40, AD converter 41, and averaging filter 42.

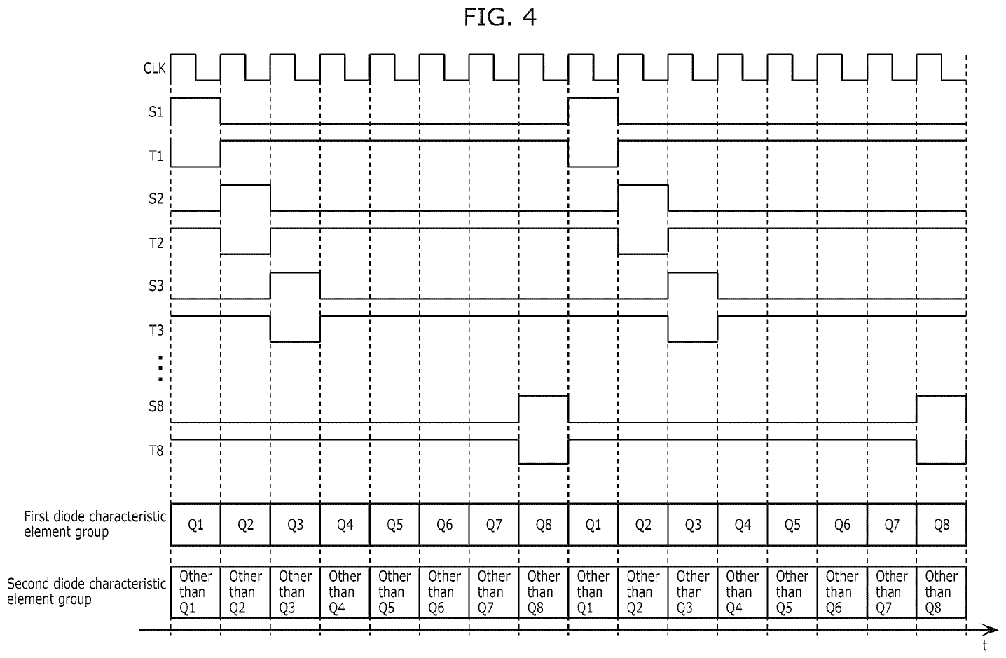

FIG. 4 is a timing chart illustrating an example of the operation performed by dynamic element matching circuit 23 illustrated in FIG. 3. In this diagram, “CLK” denotes the clock that is input to timing generation circuit 21 in FIG. 1, “S1” to “S8” denote control signals S1 to S8 that drive switches S1 to S8, “T1” to “T8” denote control signals T1 to T8 that drive switches T1 to T8, “first diode characteristic element group” denotes the diode characteristic elements that are selected as first diode characteristic element group 22a, and “second diode characteristic element group” denotes the diode characteristic elements that are selected as second diode characteristic element group 22b. It should be noted that, in “S1” through “S8” and “T1” through “T8”, level H turns on the corresponding switch and level L turns off the corresponding switch.

As illustrated in the diagram, control signals S1 to S8 and T1 to T8 control the on-off of switches S1 to S8 and T1 to T8 that constitute switch group 25. As a result: at the first CLK, diode characteristic element Q1 is selected as first diode characteristic element group 22a and seven diode characteristic elements Q2 to Q8 other than diode characteristic element Q1 are selected as second diode characteristic element group 22b; at the second CLK, diode characteristic element Q2 is selected as first diode characteristic element group 22a and seven diode characteristic elements Q1 and Q3 to Q8 other than diode characteristic element Q2 are selected as second diode characteristic element group 22b; . . . and in the same manner, at the eighth CLK, diode characteristic element Q8 is selected as first diode characteristic element group 22a and seven diode characteristic elements Q1 to Q7 other than diode characteristic element Q8 are selected as second diode characteristic element group 22b. In this manner, the similar selection state is repeated for 8 CLKs as one period.

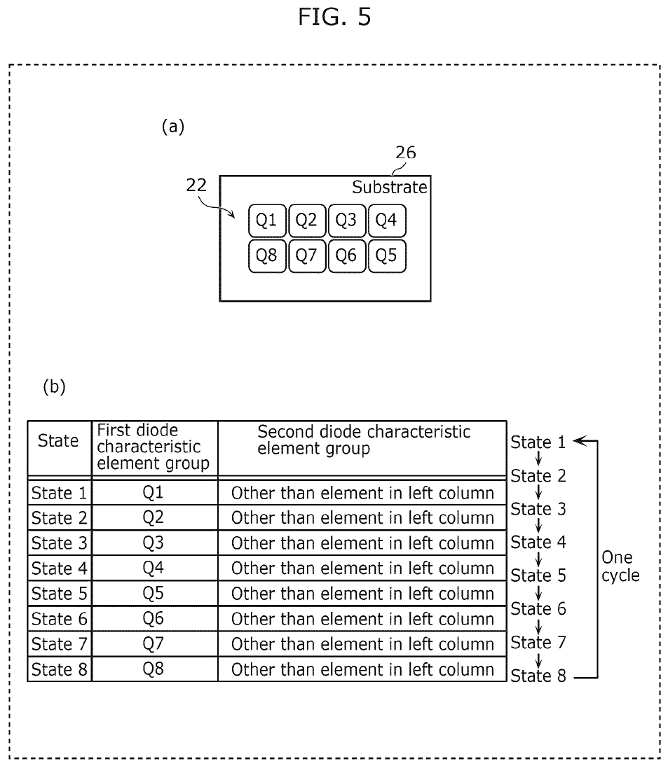

FIG. 5 is a diagram explaining the transition of the selection state illustrated in FIG. 4. FIG. 5 illustrates in (a) the arrangement position of the eight diode characteristic elements Q1 to Q8 that constitute diode characteristic element group 22 on substrate 26 included by semiconductor device 10. FIG. 5 illustrates in (b) the transition of the selection state of diode characteristic elements Q1 to Q8 illustrated in FIG. 4.

As can be seen from (b) in FIG. 5, the state transition is repeated with one cycle starting from “state 1” in which diode characteristic element Q1 is selected as first diode characteristic element group 22a and seven diode characteristic elements Q2 to Q8 other than diode characteristic element Q1 are selected as second diode characteristic element group 22b, followed by “state 2”, “state 3”, . . . , until “state 8” in which diode characteristic element Q8 is selected as first diode characteristic element group 22a and seven diode characteristic elements Q1 to Q7 other than diode characteristic element Q8 are selected as second diode characteristic element group 22b.

In this manner, according to this operation example, one diode characteristic element selected as first diode characteristic element group 22a and seven diode characteristic elements selected as second diode characteristic element group 22b are replaced at each clock, by dynamic element matching circuit 23. In any selection state, the total number of diode characteristic elements M selected as first diode characteristic element group 22a and the total number of diode characteristic elements N selected as second diode characteristic element group 22b are constant (in other words, always 1 and 7, respectively). In addition, in one period, each of diode characteristic elements Q1 to Q8 is included in first diode characteristic element group 22a a same number of times, and included in second diode characteristic element group 22b a same number of times (1 and 7 times, respectively).

In this manner, the variation in the characteristics of first diode characteristic element group 22a and second diode characteristic element group 22b due to manufacturing variation of diode characteristic elements Q1 to Q8 is suppressed, and corrected in a predetermined period. As a result, the variation, among semiconductor devices 10, of reference voltage VBG generated based on the difference between the current density of current passing through first diode characteristic element group 22a and the current density of current passing through second diode characteristic element group is suppressed.

Furthermore, since the variation in the characteristics of first diode characteristic element group 22a and second diode characteristic element group 22b due to temperature is also suppressed, the adjustment range of the current ratio 1:k for current mirror circuit 37a provided by second-order temperature coefficient adjustment circuit 37 can be reduced, or the adjustment of secondary temperature coefficient becomes unnecessary. As a result, the circuit area of band gap reference circuit 20 is reduced by reducing the circuit size of second-order temperature coefficient adjustment circuit 37 or by not providing second-order temperature coefficient adjustment circuit 37.

Next, the configuration and an example of the operation of the dynamic element matching circuit according to a variation of the present embodiment will be described.

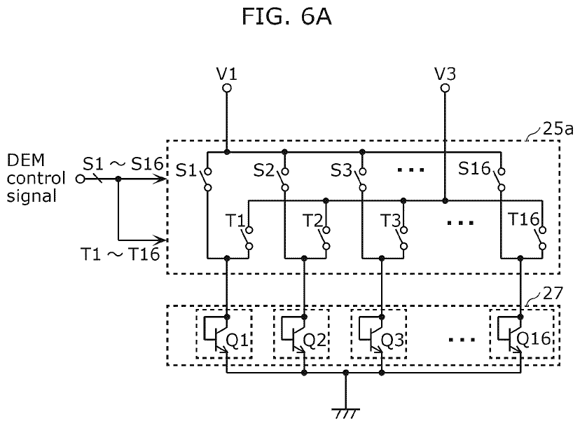

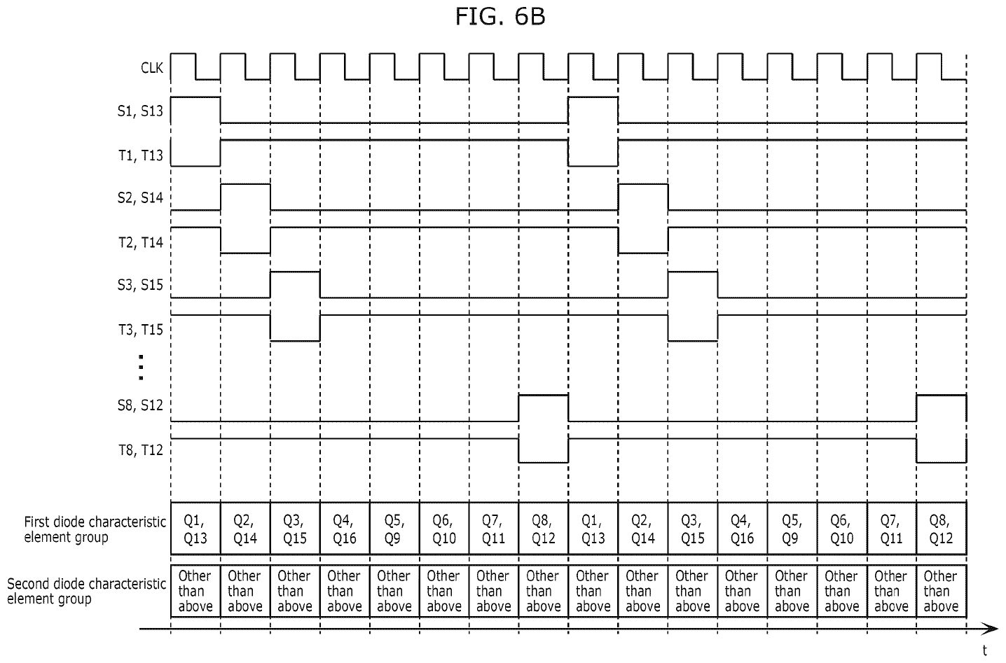

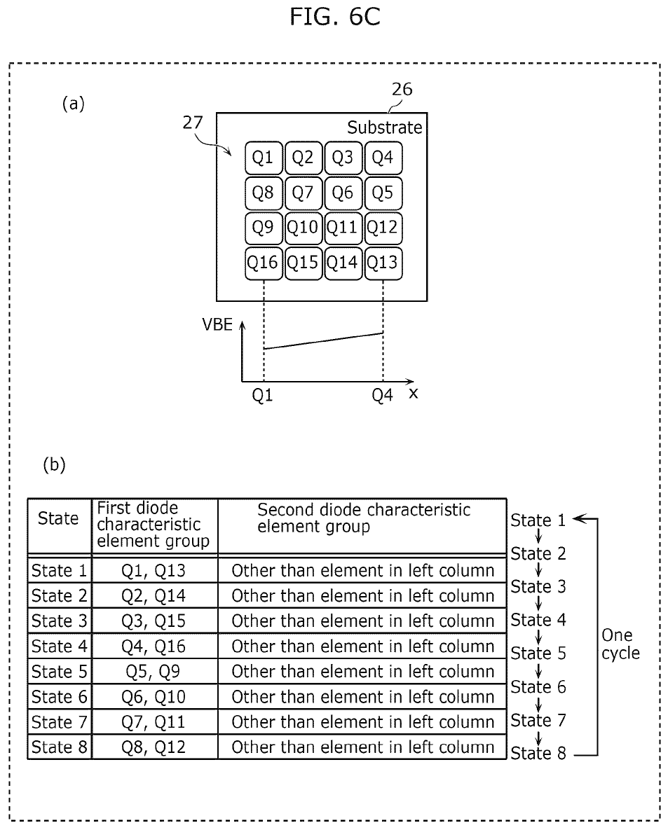

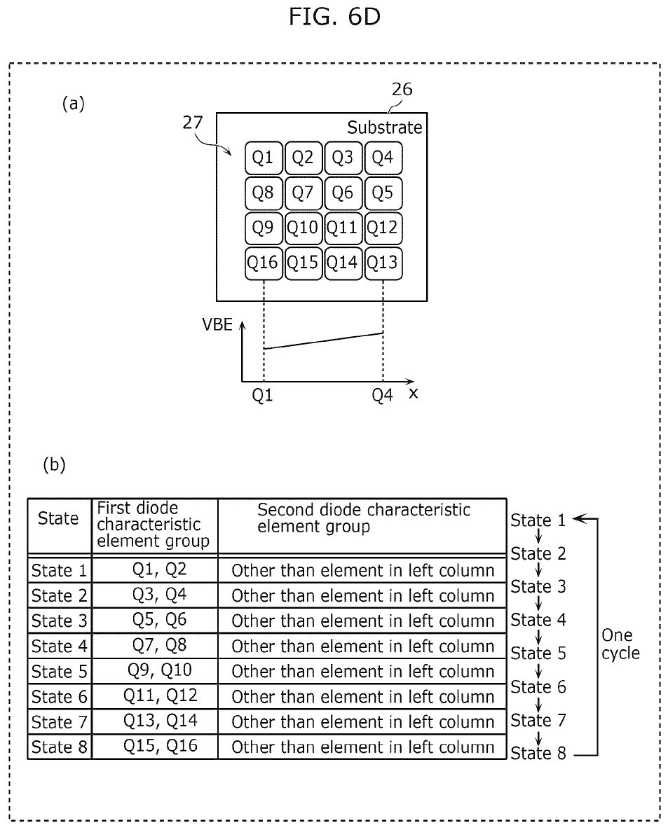

FIG. 6A is a diagram illustrating diode characteristic element group 27 and switch group 25a according to the variation. This diagram corresponds to FIG. 3 in the embodiment. However, according to the present variation, diode characteristic element group 27 is composed of 16 diode characteristic elements Q1 to Q16. In addition, switch group 25a includes: switches S1 to S16 for connecting to connection point V1 and switches T1 to T16 for connecting to connection point V3, in association with 16 diode characteristic elements Q1 to Q16.

FIG. 6B is a timing chart illustrating an operation example of the dynamic element matching circuit according to the variation illustrated in FIG. 6A. This diagram corresponds to FIG. 4 of the embodiment. However, according to the present variation, first diode characteristic element group 22a includes two diode characteristic elements selected from among 16 diode characteristic elements Q1 to Q16, and second diode characteristic element group 22b includes 14 diode characteristic elements other than the two diode characteristic elements which have been selected.

FIG. 6C is a diagram explaining the transition of the selection state illustrated in FIG. 6B. FIG. 6C illustrates in (a) the arrangement positions (layout) of the 16 diode characteristic elements Q1 to Q16 that constitute diode characteristic element group 27 on substrate 26 included by semiconductor device 10, and a graph of base-emitter voltage VBE (vertical axis) of the diode characteristic elements which depends on the arrangement positions in the X-axis direction (the arrangement positions in the direction from Q1 toward Q4, horizontal axis). FIG. 6C illustrates in (b) the transition of the selection state of diode characteristic elements Q1 to Q16 illustrated in FIG. 6B.

As illustrated in the layout in (a) of FIG. 6C, in the present variation, the 16 diode characteristic elements Q1 to Q16 are provided on substrate 26 at the locations to be placed in a 4×4 quadrilateral shape. As illustrated in the graph in (a) of FIG. 6C, base-emitter voltage VBE of each of the diode characteristic elements increases in the direction from left to right in the layout in (a) of FIG. 6C, depending on the manufacturing process of semiconductor device 10, etc.

As can be seen from this diagram, in the present variation, the arrangement positions of the two diode characteristic elements selected as first diode characteristic element group 22a on substrate 26 are point symmetrical in both selection states. For example, the arrangement positions of diode characteristic elements Q1 and Q13 selected in state 1 on substrate 26 are point symmetrical, and the arrangement positions of diode characteristic elements Q2 and Q14 selected in state 2 on substrate 26 are point symmetrical.

In the same manner as above, the arrangement positions of the 14 diode characteristic elements selected as second diode characteristic element group 22b on substrate 26 are point symmetrical in any of the selection states.

In this manner, when the diode characteristic elements that constitute diode characteristic element group 27 have characteristic dependence on the arrangement position, according to the operation example of the present variation, each of first diode characteristic element group 22a and second diode characteristic element group 22b is composed of diode characteristic elements in the point symmetrical arrangement positions, in any of the selection states. As a result, the amount of variation of reference voltage VBG generated in each selection state is suppressed and the noise due to the voltage variation between the selection states is reduced.

FIG. 6D is a diagram explaining the transition of the selection state according to a reference example. In FIG. 6D, (a) is the same as (a) of FIG. 6C. In (b) of FIG. 6D, unlike (b) in FIG. 6C, the arrangement positions of the two diode characteristic elements selected as first diode characteristic element group 22a and the 14 diode characteristic elements selected as second diode characteristic element group 22b on substrate 26 are not point symmetrical in any of the selection states.

In such a reference example, reference voltage VBG generated will vary in each selection state depending on the arrangement positions of the diode characteristic elements selected as first diode characteristic element group 22a and second diode characteristic element group 22b on substrate 26. This causes voltage variation between the selected states, which results in noise.

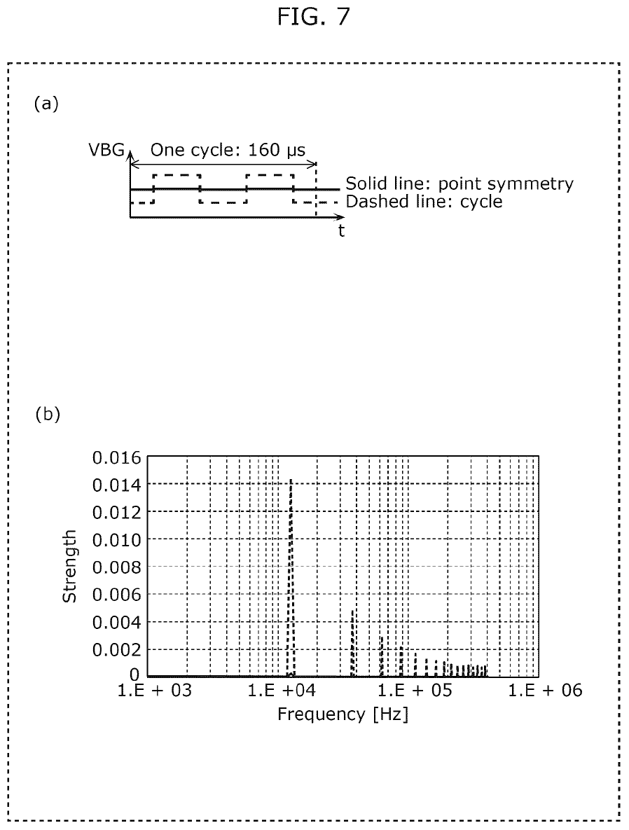

FIG. 7 is a diagram illustrating a result of simulation comparing the amount of variation (noise) in reference voltage VBG between the variation illustrated in FIG. 6C and the reference example illustrated in FIG. 6D. Here, assuming the arrangement positions of diode characteristic elements Q1 to Q16 as illustrated in (a) of FIG. 6C and (a) of FIG. 6D, and the variation of base-emitter voltage VBE, the time waveform of the amount of variation (noise) of reference voltage VBG when one cycle (period) of the selection state is 160 μs ((a) in FIG. 7) and spectrum ((b) in FIG. 7) are illustrated.

In (a) and (b) of FIG. 7, the solid line indicates the case where first diode characteristic element group 22a and second diode characteristic element group 22b are composed of diode characteristic elements in point symmetrical arrangement positions, as in the variation illustrated in FIG. 6C, and the dashed line indicates the case where first diode characteristic element group 22a and second diode characteristic element group 22b are composed of diode characteristic elements not in point symmetrical arrangement positions, as in the reference example illustrated in FIG. 6D.

As can be seen from (b) in FIG. 7, in the reference case, a noise spectrum with a plurality of peaks is observed, including a peak with a maximum at 12.5 kHz, whereas almost no noise is seen in the case of the variation.

Based on what has been described above, it can be seen that by selecting the diode characteristic elements as first diode characteristic element group 22a and second diode characteristic element group 22b to be composed of diode characteristic elements in a point symmetrical arrangement position on substrate 26, the variation (noise) of reference voltage VBG that occurs between the selection states is suppressed.

The following describes an example of the operation of dynamic element matching circuit 23 in which randomness is incorporated in selecting diode characteristic elements as first diode characteristic element group 22a and second diode characteristic element group 22b.

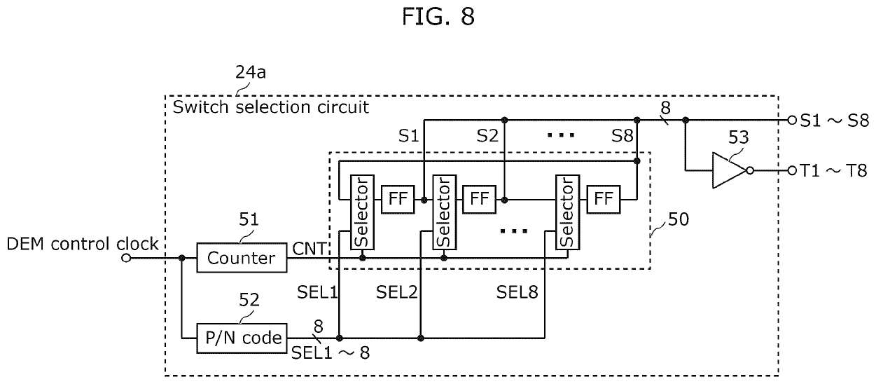

FIG. 8 is a circuit diagram illustrating a configuration example of switch selection circuit 24a that implements a dynamic element matching circuit according to the variation in which randomness is incorporated. Switch selection circuit 24a controls switch group 25 such that the selection state for eight cycles is repeated with one period (cycle) being a period in which the selection state transitions from state 1 to state 8 while randomly changing state 1. State 1 is the selection state in which one diode characteristic element randomly selected from among eight diode characteristic elements Q1 to Q8 is included in first diode characteristic element group 22a and the remaining seven diode characteristic elements are included in second diode characteristic element group 22b.

Switch selection circuit 24a includes: shift register 50 composed of eight pairs of a two-input sector and a flip-flop (FF) connected to the output of the input selector in series; counter 51 that outputs a selection control signal to each selector; pseudo-random number sequence generator 52 that provides one of the selectors with a pseudo-random number (P/N code); and inverter 53 that inverts, and outputs as control signals T1 to T8, 8-bit outputs (control signals S1 to S8) from shift register 50.

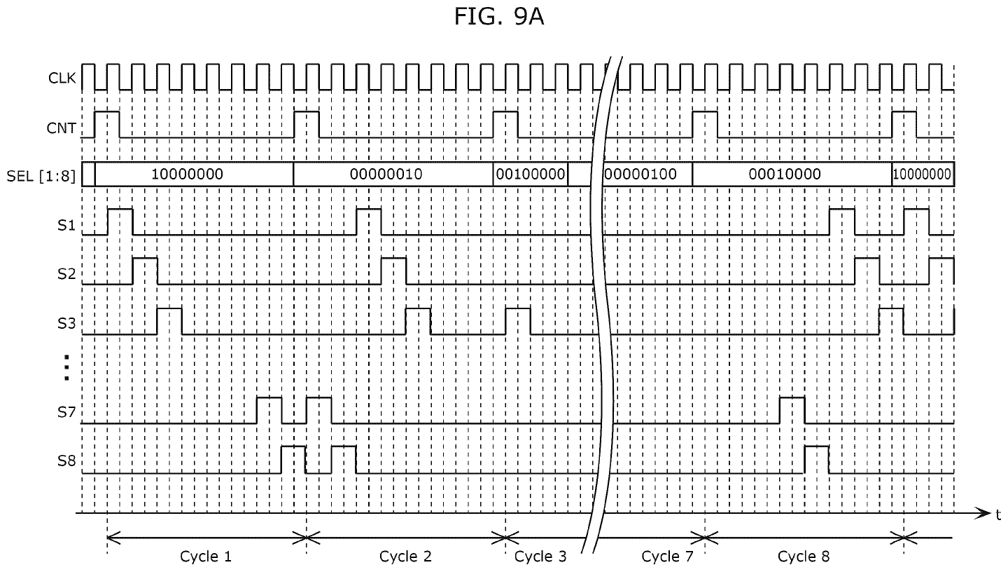

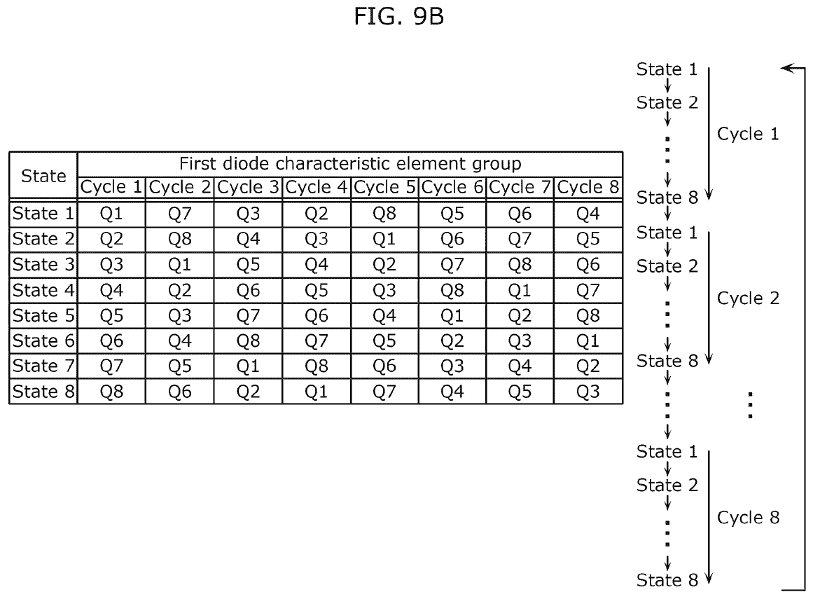

FIG. 9A is a timing chart illustrating an operation of switch selection circuit 24a illustrated in FIG. 8. In this diagram, “CLK” is a DEM control clock indicated in FIG. 8, “CNT” is an output signal of counter 51, “SEL[1:8]” is a selection control signal (8 bits) output by pseudo-random number sequence generator 52, and “S1” to “S8” are control signals S1 to S8 output from eight flip-flops that constitute shift register 50. In this diagram, the timing for eight cycles (cycles 1 to 8) is indicated where the state transitions from state 1 to state 8 in one cycle.

In this diagram, as indicated by the signal waveform of “CNT,” counter 51 outputs level H in state 1 and level L in the other states. In addition, as indicated in “SEL[1:8]”, pseudo-random number sequence generator 52 outputs, for each one cycle, a selection control signal with one bit out of 8 bits randomly being set at level H.

As a result, in each cycle, as indicated by control signals “S1” to “S8,” in state 1, shift register 50 selects signals SEL1 to SEL8 out of the two input signals, thereby determining and outputting the start position of one cycle determined by pseudo-random number sequence generator 52, and in and subsequent to state 2, the output of the flip-flop in the previous stage is selected out of the two input signals and output, thereby causing the remaining seven states to sequentially transition.

FIG. 9B is a diagram illustrating diode characteristic elements selected as first diode characteristic element group 22a by switch selection circuit 24a illustrated in FIG. 8. The diode characteristic elements selected as first diode characteristic element group 22a are indicated for cycles 1 to 8 in each of which the state transitions from state 1 to state 8. It should be noted that, in each of the states, the diode characteristic elements selected as second diode characteristic element group 22b are the seven diode characteristic elements other than the diode characteristic element selected as first diode characteristic element group 22a.

As illustrated in this diagram, in each of the cycles, the diode characteristic element selected as first diode characteristic element group 22a is diode characteristic element Q1 in cycle 1, and in cycles 2 to 8, diode characteristic elements Q7, Q3, Q2, Q8, Q5, Q6, and Q4 randomly selected from among the diode characteristic elements other than the diode characteristic element that has been already selected.

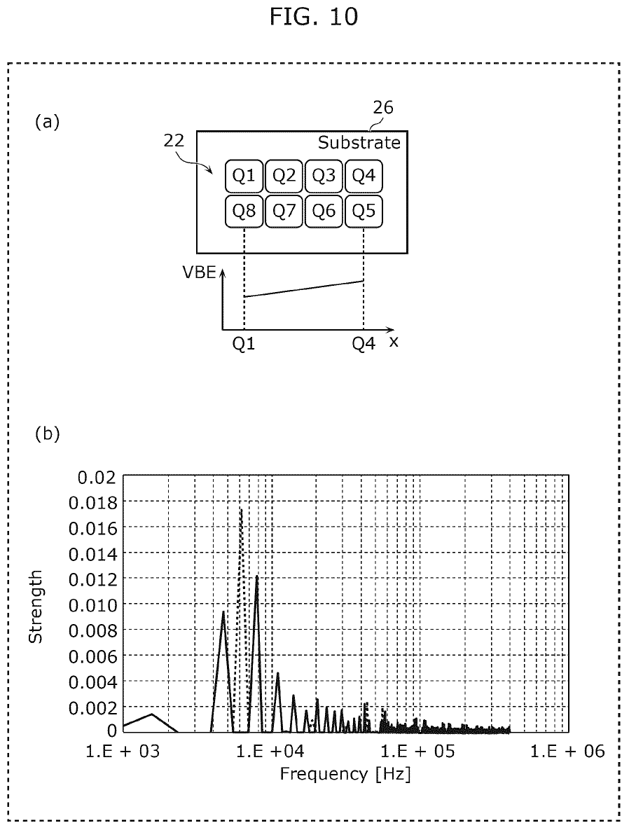

FIG. 10 is a diagram explaining the advantageous effects resulting from the operation of the dynamic element matching circuit according to the variation in which randomness is incorporated. FIG. 10 illustrates in (a) the arrangement positions (layout) of the eight diode characteristic elements Q1 to Q8 that constitute diode characteristic element group 22 on substrate 26, and a graph of base-emitter voltage VBE (vertical axis) of the diode characteristic elements which depends on the arrangement positions in the X-axis direction (horizontal axis). FIG. 10 illustrates in (b) a result of simulation comparing the amount of variation (noise) in reference voltage VBG between (i) the state transition by the dynamic element matching circuit according to the embodiment in which randomness is not incorporated as illustrated in FIG. 5 and (ii) the state transition by the dynamic element matching circuit according to the variation in which randomness is incorporated as illustrated in FIG. 9B. Here, in the same manner as the result of simulation indicated in FIG. 7, the spectrum of the amount of variation (noise) of reference voltage VBG when one cycle (period) of the selection state is 160 μs. In (b) of FIG. 10, the dashed line indicates the spectrum at the time of state transition by the dynamic element matching circuit according to the embodiment in which randomness is not incorporated as illustrated in FIG. 5, and the solid line indicates the spectrum at the time of state transition by the dynamic element matching circuit according to the variation in which randomness is incorporated as illustrated in FIG. 9B.

As can be seen from (b) in FIG. 10, the state transition in which randomness is not incorporated shows a noise peak with a large intensity at 6.25 kHz, whereas the state transition in which randomness is incorporated shows that the intensity of the noise peak is suppressed to be small.

Based on what has been described above, it can be seen that, with the dynamic element matching circuit according to the variation, the combination of the diode characteristic elements that constitute first diode characteristic element group 22a and second diode characteristic element group 22b in which randomness is incorporated suppresses the variation (noise) of reference voltage VBG generated between the selection states.

The following describes another example of the operation of dynamic element matching circuit 23 in which delta-sigma modulation is incorporated in selecting diode characteristic elements as first diode characteristic element group 22a and second diode characteristic element group 22b.

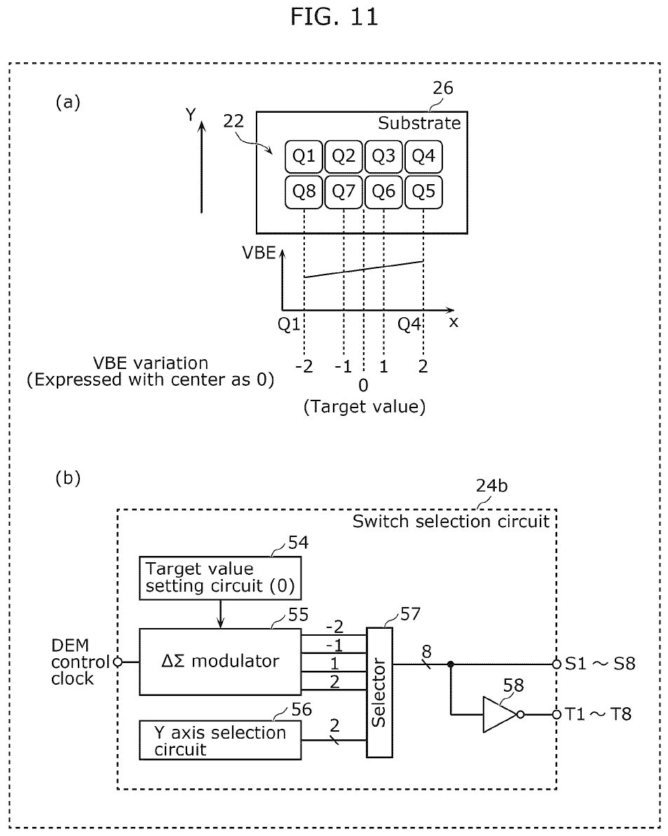

FIG. 11 is a diagram illustrating a configuration example of switch selection circuit 24b that implements a dynamic element matching circuit according to the variation in which delta-sigma modulation is incorporated. FIG. 11 illustrates in (a) a diagram in which “VBE variation (expressed with the center as 0)” is added to (a) in FIG. 10. FIG. 11 illustrates in (b) a circuit diagram illustrating a configuration example of switch selection circuit 24b.

As illustrated in (a) of FIG. 11, in this example, the target value of base-emitter voltage VBE corresponds to the center position of the arrangement position of diode characteristic elements Q1 to Q8 in the X-axis direction.

As illustrated in (b) of FIG. 11, switch selection circuit 24b includes target value setting circuit 54, delta-sigma modulator 55, Y-axis selection circuit 56, selector 57, and inverter 58.

Target value setting circuit 54 holds the target value (in this case, the arrangement position “0” in the X-axis direction), which is to be output to delta-sigma modulator 55 to be set. Delta-sigma modulator 55, with the target value (0) provided by target value setting circuit 54 as a target, repeats the operation of performing delta-sigma modulation according to the DEM control clock to select, and output to selector 57, one of the four positions (−2, −1, 1, 2) in the X-axis direction. Y-axis selection circuit 56 sequentially selects the two arrangement positions (top row and bottom row) of diode characteristic elements Q1 to Q8 in the Y-axis direction, and outputs them to selector 57. Selector 57 selects one diode characteristic element that is determined by the outputs from delta-sigma modulator 55 and Y-axis selection circuit 56, and outputs control signals S1 to S8 to switch group 25. Inverter 58 outputs, to switch group 25, control signals T1 to T8 obtained by inverting control signals S1 to S8 from selector 57.

In switch selection circuit 24b, operation is carried out according to delta-sigma modulation, and thus the selection frequency of the diode characteristic elements is more frequent in the two positions (−1, 1) in the X-axis direction, and the appearance frequency is less frequent in the two positions (−2, 2). As a result, the amount of variation due to changes in state is reduced. It is thus possible to more suppress noise compared to cyclic selection operation.

The dynamic element matching circuit including such switch selection circuit 24b as described above selects first diode characteristic element group 22a and second diode characteristic element group 22b such that, in the repeating of selection of the combination of first diode characteristic element group 22a and second diode characteristic element group 22b, the M diode characteristic elements that constitute first diode characteristic element group 22a are replaced according to delta-sigma modulation and the N diode characteristic elements that constitute second diode characteristic element group 22b are replaced according to delta-sigma modulation.

Therefore, the dynamic element matching circuit according to the variation in which the delta-sigma modulation as described above is incorporated suppresses the variation (noise) of reference voltage VBG that is generated between selection states, in the same manner as the dynamic element matching circuit according to the variation in which the above-described randomness is incorporated.

Next, another example of the layout of diode characteristic element group 28 on substrate 26 will be described.

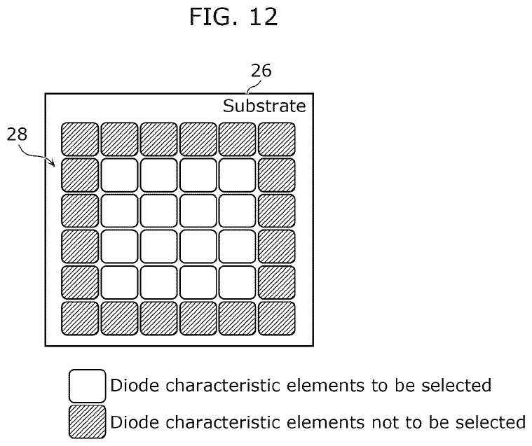

FIG. 12 is a diagram illustrating a layout of diode characteristic element group 28 on substrate 26 according to the variation. In this diagram, the 16 white quadrilaterals located in the center portion indicate the diode characteristic elements selected as first diode characteristic element group 22a and second diode characteristic element group 22b, and the 20 hatched quadrilaterals located at the peripheral edge indicate the diode characteristic elements as dummies that are not selected as first diode characteristic element group 22a or second diode characteristic element group 22b.

In other words, in the present variation, dynamic element matching circuit 23 selects first diode characteristic element group 22a and second diode characteristic element group 22b from among the plurality of diode characteristic elements other than diode characteristic elements located at a peripheral edge of diode characteristic element group 28 in a plan view of substrate 26.

In general, diode characteristic elements located at the peripheral edge of diode characteristic element group 28 have larger characteristic variation due to, for example, the irregularity in density of impurity diffusion in the semiconductor manufacturing process than the characteristic variation of diode characteristic elements located in the center portion. Therefore, according to the present variation, first diode characteristic element group 22a and second diode characteristic element group 22b are configured after excluding diode characteristic elements with large characteristic variation, and thus the characteristic variation of first diode characteristic element group 22a and second diode characteristic element group 22b which are selected is suppressed compared to the general case in which unselected diode characteristic elements are not provided at the peripheral edge.

The following describes an example of including, into diode characteristic element group 22, bipolar transistors 37b and 37c that are included in second-order temperature coefficient adjustment circuit 37, to be subjected to dynamic element matching.

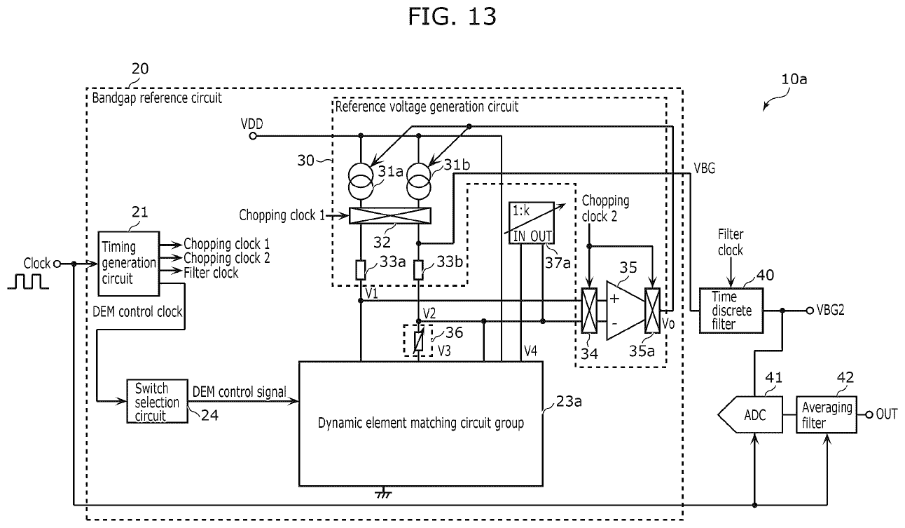

FIG. 13 is a circuit block diagram illustrating a configuration of semiconductor device 10a according to the variation in which a bipolar transistor (i.e., diode characteristic element) included in a second-order temperature coefficient adjustment circuit is included in the diode characteristic element group, and is subject to dynamic element matching. Semiconductor device 10a includes dynamic element matching circuit group 23a in place of switch group 25 and diode characteristic element group 22 in semiconductor device 10 illustrated in FIG. 1.

Dynamic element matching circuit group 23a includes connection points V1, V2, V3, VDD, and V4 as connection points with reference voltage generation circuit 30. Connection points V1, V2, V3, and VDD are identical to those illustrated in FIG. 1. Connection point V4 corresponds to input terminal IN of current mirror circuit 37a.

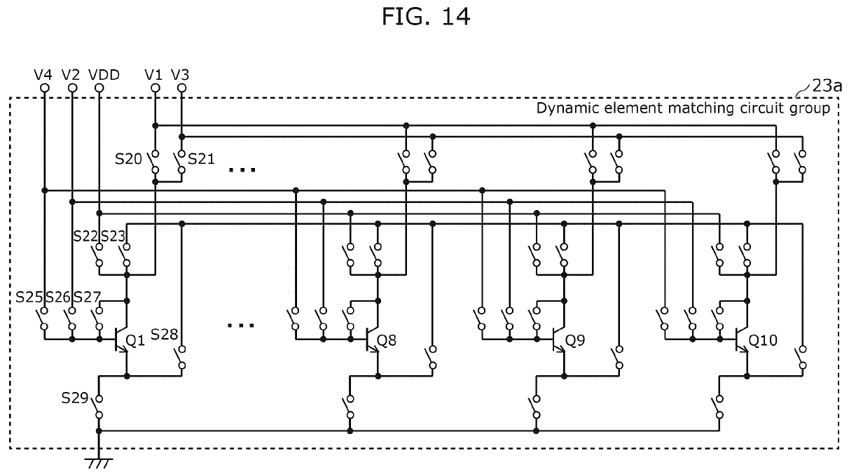

FIG. 14 is a circuit diagram illustrating a detailed configuration of dynamic element matching circuit group 23a according to FIG. 13. Dynamic element matching circuit group 23a includes ten bipolar transistors Q1 to Q10 and nine switches S20 to S23 and S25 to S29 provided for each of bipolar transistors Q1 to Q10.

In the present variation, each of the 10 bipolar transistors Q1 to Q10 can be selected as first diode characteristic element group 22a, selected as second diode characteristic element group 22b, or selected as bipolar transistor (i.e., diode characteristic elements) included in second-order temperature coefficient adjustment circuit 37, according to the DEM control signal from switch selection circuit 24.

For example, when bipolar transistor Q1 is selected as first diode characteristic element group 22a, only switches S20, S27, and S29 are turned on among switches S20 to S23 and S25 to S29, and the other switches are turned off.

In addition, when bipolar transistor Q1 is selected as second diode characteristic element group 22b, only switches S21, S27, and S29 are turned on among switches S20 to S23 and S252 to S29, and the other switches are turned off.

In addition, when bipolar transistor Q1 is selected as bipolar transistor 37b included in second-order temperature coefficient adjustment circuit 37, only switches S22, S25, and S28 are turned on among switches S20 to S23 and S25 to S29, and the other switches are turned off.

In addition, when bipolar transistor Q1 is selected as bipolar transistor 37c included in second-order temperature coefficient adjustment circuit 37, only switches S23, S26, and S29 are turned on among switches S20 to S23 and S25 to S29, and the other switches are turned off.

As described above, in the present variation, dynamic element matching circuit group 23a repeats, within a predetermined period, an operation of selecting, from diode characteristic element group (bipolar transistors Q1 to Q10), at least one diode characteristic element that functions as second-order temperature coefficient adjustment circuit 37, in addition to first diode characteristic element group 22a and second diode characteristic element group 22b, while changing the combination of M diode characteristic elements, the N diode characteristic elements, and the at least one diode characteristic element that functions as second-order temperature coefficient adjustment circuit 37, to be selected.

As a result, not only diode characteristic element group 22 but also bipolar transistors 37b and 37c that are included in secondary temperature coefficient adjustment circuit 37 are subject to dynamic element matching, and thus adjustment current Ic(t) output from secondary temperature coefficient adjustment circuit 37 is averaged, the adjustment range of the current ratio 1:k for current mirror circuit 37a of secondary temperature coefficient adjustment circuit 37 can be reduced, and thus the circuit size of secondary temperature coefficient adjustment circuit 37 is reduced.

Next, a detailed configuration example of first switch circuit 32 and second switch circuit 34 included in semiconductor device 10 according to the embodiment will be described.

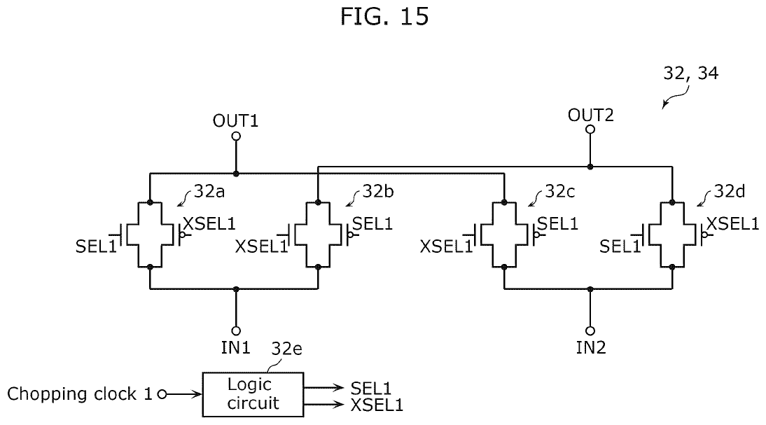

FIG. 15 is a circuit diagram illustrating a detailed configuration example of first switch circuit 32 and second switch circuit 34 in FIG. 1. First switch circuit 32 (second switch circuit 34) includes two input terminals IN1 and IN2, two output terminals OUT1 and OUT2, four switches 32a to 32d in which N-channel MOS transistors and P-channel MOS transistors are connected in parallel, and logic circuit 32e that generates control signals SEL1 and XSEL1 (inverting signal of SEL1) to be supplied to the gates of the N-channel MOS transistors and P-channel MOS transistors based on chopping clock 1 (2) input from timing generation circuit 21.

When control signals SEL1 and XSEL1 are at active levels (e.g., level H and level L, respectively), input terminals IN1 and IN2 are connected straight to output terminals OUT1 and OUT2, respectively. On the other hand, when control signals SEL1 and XSEL1 are at negative levels (e.g., level L and level H, respectively), input terminals IN1 and IN2 are connected crisscross to output terminals OUT2 and OUT1, respectively.

Therefore, first switch circuit 32 continues to switch the connection between first current supply 31a and second current supply 31b and first resistor element 33a and second resistor element 33b between straight and crisscross alternately, based on chopping clock 1 input from timing generation circuit 21. As a result, the current supply that supplies current to first diode characteristic element group 22a and the current supply that supplies current to second diode characteristic element group 22b are periodically switched between first current supply 31a and second current supply 31b.

In this manner, variation in output current due to manufacturing variation in circuit components that constitute first current supply 31a and second current supply and 31b is averaged, and the adjustment range in first-order temperature coefficient adjustment circuit 36 and second-order temperature coefficient adjustment circuit 37 can be reduced, and thus the circuit size of first-order temperature coefficient adjustment circuit 36 and second-order temperature coefficient adjustment circuit 37 can be reduced.

In the same manner as above, second switch circuit 34 continues to switch the connections between connection points V1 and V2 and the non-inverting input terminal and the inverting input terminal of differential amplifier 35 between straight and crisscross alternately, based on chopping clock 2 input from timing generation circuit 21. It should be noted that internal circuit 35a of differential amplifier 35 also switches the connection mode, according to chopping clock 2 from timing generation circuit 21, such that the same amplification operation is performed when the non-inverting input terminal and the inverting input terminal are functionally switched or not switched, in synchronization with the switching operation of second switch circuit 34.

As a result, the voltage input to the non-inverting input terminal and the voltage input to the inverting input terminal of differential amplifier 35 are periodically switched between the first voltage that depends on the current density of current passing through first diode characteristic element group 22a and the second voltage that depends on the current density of current passing through second diode characteristic element group 22b.

In this manner, it is possible to average characteristic variation such as offset voltage due to manufacturing variation in the circuit components that constitute differential amplifier 35, and reduce the adjustment range in first-order temperature coefficient adjustment circuit 36 and second-order temperature coefficient adjustment circuit 37, and thus the circuit sizes of first-order temperature coefficient adjustment circuit 36 and second-order temperature coefficient adjustment circuit 37 can be reduced.

Next, a detailed configuration example of time discrete filter 40 included in semiconductor device 10 according to the embodiment will be described.

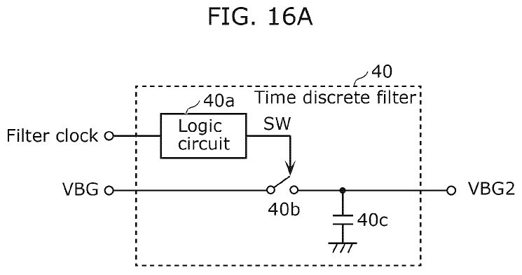

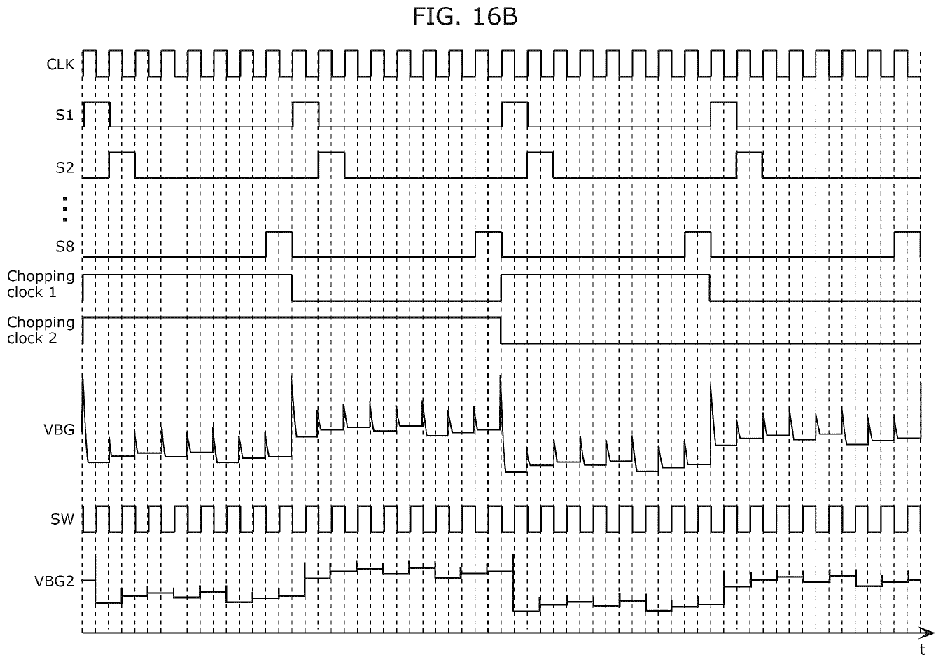

FIG. 16A is a circuit diagram illustrating a detailed configuration example of time discrete filter 40 in FIG. 1. Time discrete filter 40 is a filter that smooths reference voltage VBG generated in reference voltage generation circuit 30 and outputs it as reference voltage VBG2, and includes logic circuit 40a, switch 40b, and capacitor 40c.

Logic circuit 40a outputs drive signal SW to switch 40b in synchronization with the filter clock from timing generation circuit 21, to drive switch 40b on and off. As a result, of reference voltages VBG input to switch 40b, only the voltage at the time when the voltage is stable is allowed to pass through, smoothed by capacitor 40c, and output as reference voltage VBG2.

FIG. 16B is a timing chart illustrating an operation of time discrete filter 40 illustrated in FIG. 16A. In this diagram, “CLK” indicates the filter clock in FIG. 16A, “S1” to “S8” indicate control signals S1 to S8 that drive switches S1 to S8, and “chopping clock 1” and “chopping clock 2” indicate chopping clock 1 and 2 output by timing generation circuit 21, respectively. “VBG” indicates reference voltage VBG generated in reference voltage generation circuit 30, “SW” indicates drive signal SW output by logic circuit 40a of time discrete filter 40, and “VBG2” indicates reference voltage VBG2 output from time discrete filter 40.

As can be seen from FIG. 16B, noise is generated in reference voltage “VBG” due to the on-off of switches S1 to S8 by control signals S1 to S8, but the noise is suppressed by the time discretization (on-off at “SW”) by switch 40b of time discrete filter 40 and capacitor 40c, as indicated in reference voltage “VBG2”. In this manner, it is possible to reduce the stability latency time in capturing signals to AD converter 41 in the subsequent stage.

The following describes semiconductor device 10b according to the variation which includes an averaging filter as an analog signal processing circuit in place of time discrete filter 40, AD converter 41, and averaging filter 42 according to the embodiment.

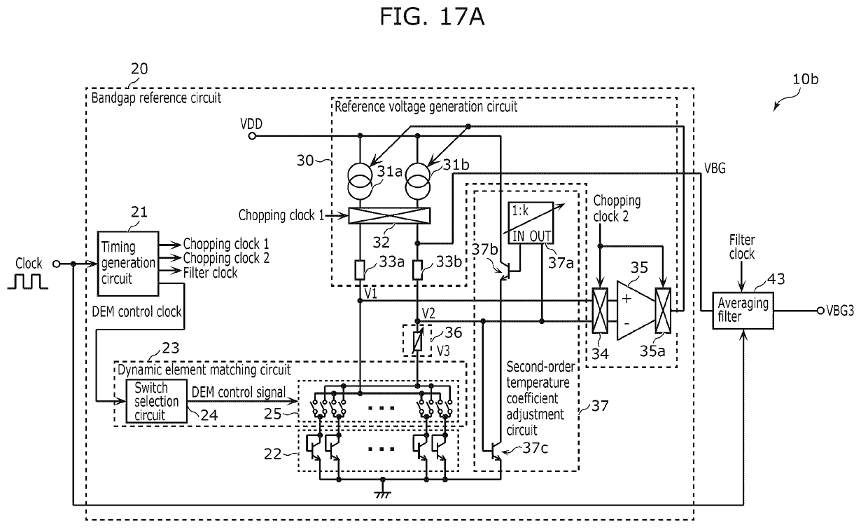

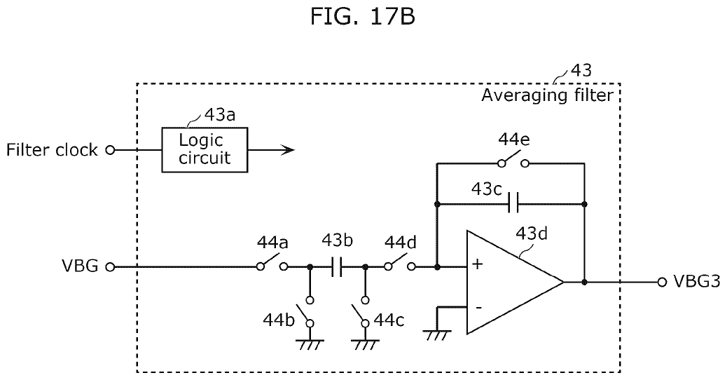

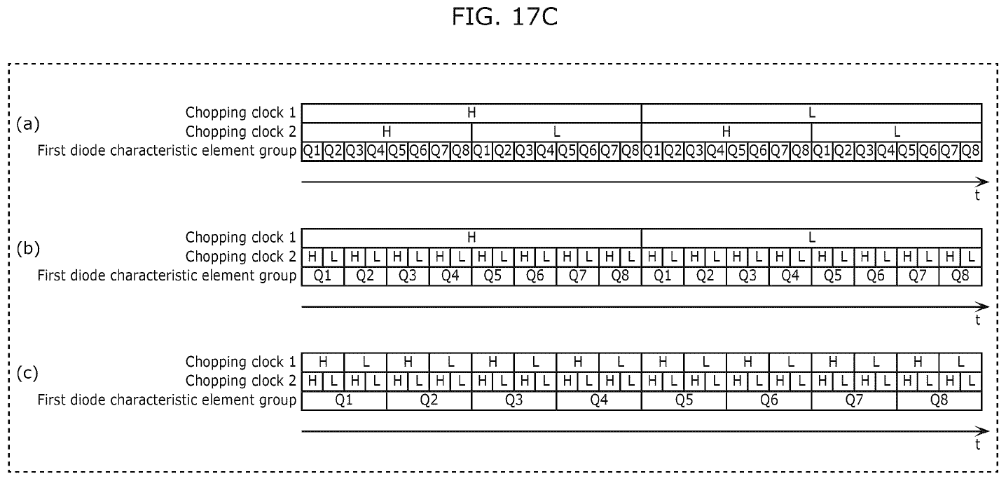

FIG. 17A is a circuit block diagram illustrating a configuration of semiconductor device 10b according to the variation which includes averaging filter 43 as an analog signal processing circuit in place of time discrete filter 40, AD converter 41, and averaging filter 42 according to the embodiment. Semiconductor device 10b includes averaging filter 43 as an analog signal processing circuit in place of time discrete filter 40, AD converter 41, and averaging filter 42 in semiconductor device 10 illustrated in FIG. 1.

FIG. 17B is a circuit diagram illustrating a detailed configuration of averaging filter 43 illustrated in FIG. 17A. Averaging filter 43 is a filter that smooths, and outputs as reference voltage VBG3, reference voltage VBG generated by reference voltage generation circuit 30, and includes logic circuit 43a, capacitors 43b and 43c, operational amplifier 43d, and switches 44a to 44e.

Logic circuit 43a controls the on-off of switches 44a to 44e in synchronization with the filter clock from timing generation circuit 21. More specifically, the on-off of switches 44a to 44d is controlled such that the state in which, among switched 44a to 44e, switches 44a and 44c are on and the other switches are off, and conversely, the state in which switches 44b and 44d are on and the other switches are off, are alternately switched. Switch 44e performs an operation of resetting (i.e., short-circuit and open) once per cycle of dynamic element matching (the cycle in which diode characteristic elements Q1 to Q8 are selected).

As a result, reference voltage VBG input to switch 44a is subject to repeatedly sampling and integration alternately, undergoes signal processing equivalent to the processing by time discrete filter 40, AD converter 41, and averaging filter 42 in the embodiment, and is output as reference voltage VBG3 which has been temporally averaged.

FIG. 17C is a diagram illustrating an example of one period in which averaging filter 43 illustrated in FIG. 17A performs the averaging processing. Here, examples of the combination (three examples of (a) to (c)) of the logic levels of chopping clocks 1 and 2 output from timing generation circuit 21 and the diode characteristic element selected as first diode characteristic element group 22a in one period in which averaging filter 43 performs the averaging process are illustrated.

In combination example (a), in one period in which averaging filter 43 performs the averaging process, chopping clock 1 is repeated for one period, chopping clock 2 is repeated for two periods, and the cycle in which diode characteristic elements Q1 to Q8 are selected as first diode characteristic element group 22a is repeated for four periods.

In combination example (b), in one period in which averaging filter 43 performs the averaging process, chopping clock 1 is repeated for one period, chopping clock 2 is repeated for 16 periods, and the cycle in which diode characteristic elements Q1 to Q8 are selected as first diode characteristic element group 22a is repeated for two periods.

In combination example (c), in one period in which averaging filter 43 performs the averaging process, chopping clock 1 is repeated for eight periods, chopping clock 2 is repeated for 16 periods, and the cycle in which diode characteristic elements Q1 to Q8 are selected as first diode characteristic element group 22a is repeated for one period.

In any of the combination examples, chopping clock 1, chopping clock 2, and the cycle in which diode characteristic elements Q1 to Q8 are selected as first diode characteristic element group 22a are synchronized, and one period in which averaging filter 43 performs the averaging process is the least common multiple of the period of chopping clock 1, the period of chopping clock 2, and the period in which dynamic element matching circuit 23 repeats the selecting of first diode characteristic element group 22a and second diode characteristic element group 22b.

Therefore, reference voltage VBG3 output from averaging filter 43 is averaged by all combinations of chopping clock 1, chopping clock 2, and the operation of dynamic element matching circuit 23, and thus variation of elements and circuits (diode characteristic element, resistor element, differential amplifier) is efficiently suppressed.

It should be noted that, although FIG. 17C shows an example of one period in which averaging filter 43 illustrated in FIG. 17A performs the averaging process, FIG. 17C may alternatively be an example of one period in which averaging filter 42 illustrated in FIG. 1 performs the averaging process.

As described above, bandgap reference circuit 20 according to the embodiment described above includes: a diode characteristic element group including a plurality of diode characteristic elements; dynamic element matching circuit 23 that repeats, within a predetermined period, an operation of selecting, from diode characteristic element group 22, a first diode characteristic element group 22a including M diode characteristic elements connected in parallel and a second diode characteristic element group 22b including N diode characteristic elements connected in parallel, while changing a combination of the M diode characteristic elements and the N diode characteristic elements to be selected, M being an integer greater than or equal to 1, N being an integer greater than or equal to 2 and greater than M; reference voltage generation circuit 30 that generates a reference voltage VBG based on a difference between a current density of current passing through the first diode characteristic element group 22a and a current density of current passing through the second diode characteristic element group 22b; and a second-order temperature coefficient adjustment circuit 37 that adjusts a second-order temperature coefficient of the reference voltage VBG generated in reference voltage generation circuit 30.

With this configuration, dynamic element matching circuit 23 generates reference voltage VBG while replacing the M diode characteristic elements that constitute first diode characteristic element group 22a and the N diode characteristic elements that constitute second diode characteristic element group 22b. Therefore, the characteristics of first diode characteristic element group 22a and second diode characteristic element group 22b are averaged, and thus a band gap reference circuit in which the characteristic variation is suppressed is implemented. As a result, the adjustment range of second-order temperature coefficient adjustment circuit 37 can be reduced, and thus the circuit size of second-order temperature coefficient adjustment circuit 37 can be reduced.

In addition, bandgap reference circuit 20 further includes first-order temperature coefficient adjustment circuit 36 that adjusts a first-order temperature coefficient of reference voltage VBG generated in reference voltage generation circuit 30. With this configuration, the first-order temperature coefficient of reference voltage VBG generated is suppressed.

In addition, a sum of M and N is a power of two. This simplifies the digital circuit that generates the combination of M diode characteristic elements and N diode characteristic elements to be selected in dynamic element matching circuit 23.

In addition, dynamic element matching circuit 23 so selects first diode characteristic element group 22a and second diode characteristic element group 22b that a ratio of M to N takes a same value in each of the repeating. This suppresses the characteristic change of first diode characteristic element group 22a and second diode characteristic element group 22b compared to the case where the ratio of M to N changes, and thus noise generated when replacing the diode characteristic elements that constitute first diode characteristic element group 22a and second diode characteristic element group 22b is suppressed.

In addition, dynamic element matching circuit 23 so selects first diode characteristic element group 22a and second diode characteristic element group 22b that, within the predetermined period, each of the plurality of diode characteristic elements selected is included in first diode characteristic element group 22a a same number of times, and included in second diode characteristic element group a same number of times 22b. In this manner, each of the diode characteristic elements that constitute diode characteristic element group 22 selected is included in first diode characteristic element group 22a a same number of times, and included in second diode characteristic element group 22b a same number of times, which suppresses the characteristic change of first diode characteristic element group 22a and second diode characteristic element group 22b. As a result, noise generated when replacing the diode characteristic elements that constitute first diode characteristic element group 22a and second diode characteristic element group 22b is suppressed.

In addition, diode characteristic element group 22 is disposed on a substrate, and dynamic element matching circuit 23 so selects first diode characteristic element group 22a and second diode characteristic element group 22b that, in a plan view of the substrate, the M diode characteristic elements are arranged point symmetrically on the substrate and the N diode characteristic elements are arranged point symmetrically on the substrate. This suppresses the dependency of first diode characteristic element group 22a and second diode characteristic element group 22b on the arrangement position, even when the diode characteristic elements that constitute diode characteristic element group 22 have characteristic variation that depends on the arrangement position.

In addition, in the above-described variation, dynamic element matching circuit 23 so selects first diode characteristic element group 22a and second diode characteristic element group 22b that, in the repeating of selecting a combination of first diode characteristic element group 22a and second diode characteristic element group 22b, the M diode characteristic elements that constitute first diode characteristic element group 22a are randomly replaced and the N diode characteristic elements that constitute second diode characteristic element group 22b are randomly replaced. In this manner, the diode characteristic elements selected as first diode characteristic element group 22a and second diode characteristic element group 22b are randomly replaced, and thus noise generated when replacing the diode characteristic elements that constitute first diode characteristic element group 22a and second diode characteristic element group 22b is suppressed.

In addition, in the above-described variation, dynamic element matching circuit 23 so selects first diode characteristic element group 22a and second diode characteristic element group 22b that, in the repeating of selecting a combination of first diode characteristic element group 22a and second diode characteristic element group 22b, the M diode characteristic elements that constitute first diode characteristic element group 22a are replaced according to delta-sigma modulation and the N diode characteristic elements that constitute second diode characteristic element group 22b are replaced according to delta-sigma modulation. In this manner, the diode characteristic elements selected as first diode characteristic element group 22a and second diode characteristic element group 22b are replaced according to delta-sigma modulation, and thus noise generated when replacing the diode characteristic elements that constitute first diode characteristic element group 22a and second diode characteristic element group 22b is suppressed.

In addition, in the above-described variation, diode characteristic element group 22 is disposed on a substrate, and dynamic element matching circuit 23 selects first diode characteristic element group 22a and second diode characteristic element group 22b from among the plurality of diode characteristic elements other than diode characteristic elements located at a peripheral edge of diode characteristic element group 28 in a plan view of substrate 26. In this manner, first diode characteristic element group 22a and second diode characteristic element group 22b are configured after excluding diode characteristic elements with large characteristic variation, and thus the characteristic variation of first diode characteristic element group 22a and second diode characteristic element group 22b which are selected is suppressed compared to the general case in which unselected diode characteristic elements are not provided at the peripheral edge.

In addition, in the above-described variation, dynamic element matching circuit 23a repeats, within a predetermined period, an operation of selecting, from the diode characteristic element group (bipolar transistors Q1 to Q10), at least one diode characteristic element that functions as second-order temperature coefficient adjustment circuit 37 in addition to first diode characteristic element group 22a and second diode characteristic element group 22b, while changing a combination of the M diode characteristic elements, the N diode characteristic elements, and the at least one diode characteristic element to be selected. In this manner, at least one diode characteristic element that functions as second-order temperature coefficient adjustment circuit 37 is also included to be subjected to dynamic element matching, and thus the characteristic variation of the diode characteristic elements that constitute second-order temperature coefficient adjustment circuit 37 can be suppressed and the adjustment range of second-order temperature coefficient adjustment circuit 37 can be reduced. As a result, it is possible to reduce the circuit size of second-order temperature coefficient adjustment circuit 37.

In addition, bandgap reference circuit 20 according to the embodiment further includes: first current supply 31a and second current supply 31b; a first diode characteristic element that receives current supply from one of first current supply 31a or second current supply 31b; a second diode characteristic element that receives current supply from an other of first current supply 31a or second current supply 31b, and is different from the first diode characteristic element in current density of current passing therethrough; reference voltage generation circuit 30 that generates reference voltage VBG based on a difference in current density; first-order temperature coefficient adjustment circuit 36 that adjusts a first-order temperature coefficient of reference voltage VBG generated in reference voltage generation circuit 30; second-order temperature coefficient adjustment circuit 37 that adjusts a second-order temperature coefficient of reference voltage VBG generated in reference voltage generation circuit 30; and first switch circuit 32 that periodically switches a current supply that supplies current to the first diode characteristic element and a current supply that supplies current to the second diode characteristic element between first current supply 31a and second current supply 32b.

With this configuration, it is possible to suppress the characteristic variation of the band gap reference circuit due to the characteristic difference between first current supply 31a and second current supply 31b.

In addition, bandgap reference circuit 20 according to the embodiment further includes: first current supply 31a and second current supply 31b; a first diode characteristic element that receives current supply from one of first current supply 31a or second current supply 31b; a second diode characteristic element that receives current supply from an other of first current supply 31a or second current supply 31b, and is different from the first diode characteristic element in current density of current passing therethrough; reference voltage generation circuit 30 that generates reference voltage VBG based on a difference in current density; first-order temperature coefficient adjustment circuit 36 that adjusts a first-order temperature coefficient of reference voltage VBG generated in reference voltage generation circuit 30; and second-order temperature coefficient adjustment circuit 37 that adjusts a second-order temperature coefficient of reference voltage VBG generated in reference voltage generation circuit 30. In the bandgap reference circuit, reference voltage generation circuit 30 includes: differential amplifier 35 including: a first input terminal and a second input terminal to which a first voltage and a second voltage are input, the first voltage being dependent on a current density of current passing through the first diode characteristic element, the second voltage being dependent on a current density of current passing through the second diode characteristic element; and second switch circuit 34 that periodically switches a voltage that is input to the first input terminal and a voltage that is input to the second input terminal between the first voltage and the second voltage.

With this configuration, it is possible to suppress the characteristic variation of the band gap reference circuit due to the characteristic variation of the circuit components that constitute difference amplifier 35.

In addition, bandgap reference circuit 20 further includes dynamic element matching circuit 23 that repeats, within a predetermined period, an operation of (i) selecting, as the first diode characteristic element, from diode characteristic element group 22 including a plurality of diode characteristic elements, first diode characteristic element group 22a including M diode characteristic elements connected in parallel and (ii) selecting, as the second diode characteristic element, from diode characteristic element group 22, second diode characteristic element group 22b including N diode characteristic elements connected in parallel, while changing a combination of the M diode characteristic elements and the N diode characteristic elements to be selected, M being an integer greater than or equal to 1, N being an integer greater than or equal to 1.

With this configuration, the characteristics of first diode characteristic element group 22a and second diode characteristic element group 22b are averaged, and thus noise generated when replacing the diode characteristic elements that constitute first diode characteristic element group 22a and second diode characteristic element group 22b is suppressed.

In addition, semiconductor device 10 according to the above-described embodiment includes bandgap reference circuit 20 described above; and time discrete filter 40 that receives reference voltage VBG output from bandgap reference circuit 20. In semiconductor device 10, dynamic element matching circuit 23 repeats the operation in synchronization with a clock signal, and time discrete filter 40 performs time discrete filtering in synchronization with the clock signal. With this configuration, the generation of noise caused by switching operations in dynamic element matching circuit 23, first switch circuit 32, and second switch circuit 34 is suppressed.

In addition, semiconductor device 10b according to the above-described variation includes bandgap reference circuit 20 described above; and averaging filter 43 that receives reference voltage VBG output from bandgap reference circuit 20. In semiconductor device 10b, dynamic element matching circuit 23 repeats the operation in synchronization with a clock signal, and averaging filter 43 performs averaging filtering in synchronization with the clock signal. With this configuration, noise generated when replacing the diode characteristic elements that constitute first diode characteristic element group 22a and second diode characteristic element group 22b is suppressed.

In addition, semiconductor device 10 according to the above-described embodiment includes bandgap reference circuit 20 described above; and analog-digital (AD) converter 41 that receives reference voltage VBG output from bandgap reference circuit 20. In semiconductor device 10, dynamic element matching circuit 23 repeats the operation in synchronization with a clock signal, and AD converter 41 converts reference voltage VBG into a digital signal in synchronization with the clock signal. With this configuration, the timing of switching in dynamic element matching circuit 23 and the timing of sampling in AD converter 41 are staggered, and thus an error in output from AD converter 41 is suppressed.

In addition, semiconductor device 10b according to the above-described variation includes: first current supply 31a and second current supply 31b; diode characteristic element group 22 including a plurality of diode characteristic elements; dynamic element matching circuit 23 that repeats, within a predetermined period, an operation of selecting, from diode characteristic element group 22, (i) first diode characteristic element group 22a that includes M diode characteristic elements connected in parallel and receives current supply from one of first current supply 31a or second current supply 31b and (ii) second diode characteristic element group 22b that includes N diode characteristic elements connected in parallel and receives current supply from an other of first current supply 31a or second current supply 31b, while changing a combination of the M diode characteristic elements and the N diode characteristic elements to be selected, M being an integer greater than or equal to 1, N being an integer greater than or equal to 2 and greater than M; first switch circuit 32 that periodically switches a current supply that supplies current to first diode characteristic element group 22a and a current supply that supplies current to second diode characteristic element group 22b between first current supply 31a and second current supply 31; reference voltage generation circuit 30 that generates reference voltage VBG based on a difference between a current density of current passing through first diode characteristic element group 22a and a current density of current passing through second diode characteristic element group 22b, and includes: differential amplifier 35 including a first input terminal and a second input terminal to which a first voltage and a second voltage are input; and second switch circuit 34 that periodically switches a voltage that is input to the first input terminal and a voltage that is input to the second input terminal between the first voltage and the second voltage, the first voltage being dependent on a current density of current passing through first diode characteristic element group 22a, the second voltage being dependent on a current density of current passing through second diode characteristic element group 22b; second-order temperature coefficient adjustment circuit 37 that adjusts a second-order temperature coefficient of reference voltage VBG generated in reference voltage generation circuit 30; and averaging filter 43 that receives reference voltage VBG output from reference voltage generation circuit 30, wherein averaging filter 43 averages the reference voltage in a period that is a least common multiple of the predetermined period in the operation of selecting performed by dynamic element matching circuit 23, a period in the switching performed by first switch circuit 32, and a period in the switching performed by second switch circuit 34.

With this configuration, reference voltage VBG is averaged by averaging filter 43 for each of the predetermined period in the operation of selecting performed by dynamic element matching circuit 23, a period in the switching performed by first switch circuit 32, and a period in the switching performed by second switch circuit 34. As a result, noise in reference voltage VBG is efficiently suppressed.

Although the bandgap reference circuit and the semiconductor device according to the present disclosure have been described based on the embodiment and variations thus far, the present disclosure is not limited to these embodiment and variations described above. Those skilled in the art will readily appreciate that various modifications may be made in these embodiment and variations and that other embodiments may be obtained by arbitrarily combining the structural components of these embodiment and variations without materially departing from the novel teachings and advantages of the present disclosure.

For example, band gap reference circuit 20 according to the above-described embodiment includes first-order temperature coefficient adjustment circuit 36, first switch circuit 32, and second switch circuit 34, but these are not necessarily required for the band gap reference circuit. By providing dynamic element matching circuit 23, it is possible to implement a band gap reference circuit that can yield the unique advantageous effect of suppressing characteristic variation, which cannot be yielded by conventional techniques.

In addition, although band gap reference circuit 20 according to the above-described embodiment includes timing generation circuit 21, first current supply 31a, and second current supply 31b, these structural components are not necessarily required. These structural components may be provided outside of band gap reference circuit 20, and used as structural components of band gap reference circuit 20.

In addition, first switch circuit 32 and second switch circuit 34 included in band gap reference circuit 20 according to the above-described embodiment do not necessarily require dynamic element matching circuit 23 and diode characteristic element group 22. In place of dynamic element matching circuit 23 and diode characteristic element group 22, it is sufficient if a first diode characteristic element and a second diode characteristic element through which current of a current density different from a current density of current passing through the first diode characteristic element passes are provided. In such a case, the first diode characteristic element and the second diode characteristic element may be a single diode characteristic element or may be composed of two or more diode characteristic elements connected in parallel.

### INDUSTRIAL APPLICABILITY

The band gap reference circuit and the semiconductor device according to the present disclosure can be used as a band gap reference circuit and a semiconductor device in which characteristic variation is suppressed, for example, as a reference voltage generation circuit for use in an AD converters or a voltage measuring device that require high accuracy and high stability.

1. A bandgap reference circuit comprising:
a diode characteristic element group including a plurality of diode characteristic elements;
a dynamic element matching circuit that repeats, within a predetermined period, an operation of selecting, from the diode characteristic element group, a first diode characteristic element group including M diode characteristic elements connected in parallel and a second diode characteristic element group including N diode characteristic elements connected in parallel, while changing a combination of the M diode characteristic elements and the N diode characteristic elements to be selected, M being an integer greater than or equal to 1, N being an integer greater than or equal to 2 and greater than M;
a reference voltage generation circuit that generates a reference voltage based on a difference between a current density of current passing through the first diode characteristic element group and a current density of current passing through the second diode characteristic element group; and
a second-order temperature coefficient adjustment circuit that adjusts a second-order temperature coefficient of the reference voltage generated in the reference voltage generation circuit.

2. The bandgap reference circuit according to claim 1, further comprising:
a first-order temperature coefficient adjustment circuit that adjusts a first-order temperature coefficient of the reference voltage generated in the reference voltage generation circuit.

3. The bandgap reference circuit according to claim 1, wherein
a sum of M and N is a power of two.

4. The bandgap reference circuit according to claim 1, wherein
the dynamic element matching circuit so selects the first diode characteristic element group and the second diode characteristic element group that a ratio of M to N takes a same value in each of the repeating.

5. The bandgap reference circuit according to claim 1, wherein
the dynamic element matching circuit so selects the first diode characteristic element group and the second diode characteristic element group that, within the predetermined period, each of the plurality of diode characteristic elements selected is included in the first diode characteristic element group a same number of times, and included in the second diode characteristic element group a same number of times.

6. The bandgap reference circuit according to claim 1, wherein
the diode characteristic element group is disposed on a substrate, and
the dynamic element matching circuit so selects the first diode characteristic element group and the second diode characteristic element group that, in a plan view of the substrate, the M diode characteristic elements are arranged point symmetrically on the substrate and the N diode characteristic elements are arranged point symmetrically on the substrate.

7. The bandgap reference circuit according to claim 1, wherein
the dynamic element matching circuit so selects the first diode characteristic element group and the second diode characteristic element group that, in the repeating, the M diode characteristic elements are randomly replaced and the N diode characteristic elements are randomly replaced.

8. The bandgap reference circuit according to claim 1, wherein
the dynamic element matching circuit so selects the first diode characteristic element group and the second diode characteristic element group that, in the repeating, the M diode characteristic elements are replaced according to delta-sigma modulation and the N diode characteristic elements are replaced according to delta-sigma modulation.

9. The bandgap reference circuit according to claim 1, wherein
the diode characteristic element group is disposed on a substrate, and
the dynamic element matching circuit selects the first diode characteristic element group and the second diode characteristic element group from among the plurality of diode characteristic elements other than diode characteristic elements located at a peripheral edge of the plurality of diode characteristic element group in a plan view of the substrate.

10. The bandgap reference circuit according to claim 1, wherein
the dynamic element matching circuit repeats, within a predetermined period, an operation of selecting, from the diode characteristic element group, at least one diode characteristic element that functions as the second-order temperature coefficient adjustment circuit in addition to the first diode characteristic element group and the second diode characteristic element group, while changing a combination of the M diode characteristic elements, the N diode characteristic elements, and the at least one diode characteristic element to be selected.

11. A bandgap reference circuit comprising:
a first current supply and a second current supply;
a first diode characteristic element that receives current supply from one of the first current supply or the second current supply;
a second diode characteristic element that receives current supply from an other of the first current supply or the second current supply, and is different from the first diode characteristic element in current density of current passing therethrough;
a reference voltage generation circuit that generates a reference voltage based on a difference in current density;
a first-order temperature coefficient adjustment circuit that adjusts a first-order temperature coefficient of the reference voltage generated in the reference voltage generation circuit;
a second-order temperature coefficient adjustment circuit that adjusts a second-order temperature coefficient of the reference voltage generated in the reference voltage generation circuit; and
a first switch circuit that periodically switches a current supply that supplies current to the first diode characteristic element and a current supply that supplies current to the second diode characteristic element between the first current supply and the second current supply.

12. A bandgap reference circuit comprising:
a first current supply and a second current supply;
a first diode characteristic element that receives current supply from one of the first current supply or the second current supply;
a second diode characteristic element that receives current supply from an other of the first current supply or the second current supply, and is different from the first diode characteristic element in current density of current passing therethrough;
a reference voltage generation circuit that generates a reference voltage based on a difference in current density;
a first-order temperature coefficient adjustment circuit that adjusts a first-order temperature coefficient of the reference voltage generated in the reference voltage generation circuit; and
a second-order temperature coefficient adjustment circuit that adjusts a second-order temperature coefficient of the reference voltage generated in the reference voltage generation circuit, wherein
the reference voltage generation circuit includes:
a differential amplifier including: a first input terminal and a second input terminal to which a first voltage and a second voltage are input, the first voltage being dependent on a current density of current passing through the first diode characteristic element, the second voltage being dependent on a current density of current passing through the second diode characteristic element; and
a second switch circuit that periodically switches a voltage that is input to the first input terminal and a voltage that is input to the second input terminal between the first voltage and the second voltage.

13. The bandgap reference circuit according to claim 11, further comprising:
a dynamic element matching circuit that repeats, within a predetermined period, an operation of (i) selecting, as the first diode characteristic element, from the diode characteristic element group including a plurality of diode characteristic elements, a first diode characteristic element group including M diode characteristic elements connected in parallel and (ii) selecting, as the second diode characteristic element, from the diode characteristic element group, a second diode characteristic element group including N diode characteristic elements connected in parallel, while changing a combination of the M diode characteristic elements and the N diode characteristic elements to be selected, M being an integer greater than or equal to 1, N being an integer greater than or equal to 1.

14. The bandgap reference circuit according to claim 12, further comprising:
a dynamic element matching circuit that repeats, within a predetermined period, an operation of (i) selecting, as the first diode characteristic element, from the diode characteristic element group including a plurality of diode characteristic elements, a first diode characteristic element group including M diode characteristic elements connected in parallel and (ii) selecting, as the second diode characteristic element, from the diode characteristic element group, a second diode characteristic element group including N diode characteristic elements connected in parallel, while changing a combination of the M diode characteristic elements and the N diode characteristic elements to be selected, M being an integer greater than or equal to 1, N being an integer greater than or equal to 1.

15. A semiconductor device comprising:
the bandgap reference circuit according to claim 13; and
a time discrete filter that receives the reference voltage output from the bandgap reference circuit, wherein
the dynamic element matching circuit repeats the operation in synchronization with a clock signal, and
the time discrete filter performs time discrete filtering in synchronization with the clock signal.

16. A semiconductor device comprising:
the bandgap reference circuit according to claim 13; and
an averaging filter that receives the reference voltage output from the bandgap reference circuit, wherein
the dynamic element matching circuit repeats the operation in synchronization with a clock signal, and
the averaging filter performs averaging filtering in synchronization with the clock signal.

17. A semiconductor device comprising:
the bandgap reference circuit according to claim 13; and
an analog-digital (AD) converter that receives the reference voltage output from the bandgap reference circuit, wherein
the dynamic element matching circuit repeats the operation in synchronization with a clock signal, and
the AD converter converts the reference voltage into a digital signal in synchronization with the clock signal.

18. A semiconductor device comprising:
a first current supply and a second current supply;
a diode characteristic element group including a plurality of diode characteristic elements;
a dynamic element matching circuit that repeats, within a predetermined period, an operation of selecting, from the diode characteristic element group, (i) a first diode characteristic element group that includes M diode characteristic elements connected in parallel and receives current supply from one of the first current supply or the second current supply and (ii) a second diode characteristic element group that includes N diode characteristic elements connected in parallel and receives current supply from an other of the first current supply or the second current supply, while changing a combination of the M diode characteristic elements and the N diode characteristic elements to be selected, M being an integer greater than or equal to 1, N being an integer greater than or equal to 2 and greater than M;
a first switch circuit that periodically switches a current supply that supplies current to the first diode characteristic element group and a current supply that supplies current to the second diode characteristic element group between the first current supply and the second current supply;
a reference voltage generation circuit that generates a reference voltage based on a difference between a current density of current passing through the first diode characteristic element group and a current density of current passing through the second diode characteristic element group, and includes: a differential amplifier including a first input terminal and a second input terminal to which a first voltage and a second voltage are input; and a second switch circuit that periodically switches a voltage that is input to the first input terminal and a voltage that is input to the second input terminal between the first voltage and the second voltage, the first voltage being dependent on a current density of current passing through the first diode characteristic element group, the second voltage being dependent on a current density of current passing through the second diode characteristic element group;
a second-order temperature coefficient adjustment circuit that adjusts a second-order temperature coefficient of the reference voltage generated in the reference voltage generation circuit; and
an averaging filter that receives the reference voltage output from the reference voltage generation circuit, wherein
the averaging filter averages the reference voltage in a period that is a least common multiple of the predetermined period in the operation of selecting performed by the dynamic element matching circuit, a period in the switching performed by the first switch circuit, and a period in the switching performed by the second switch circuit.
